(19) United States
(12) Patent Application Publication
(10) Pub. No.: US 2008/0025208 A1
(43) Pub. Date: Jan. 31, 2008

(54) WIDE-AREA WIRELESS NETWORK TOPOLOGY

(76) Inventor: Michael Tin Yau Chan, Victoria (CA)

Correspondence Address: ROBERT H. BARRIGAR;BARRIGAR INTELLECTUAL PROPERTY LAW, 1007 FORT STREET, SUITE 201, VICTORIA, BC, V8V 3K5, US

(21) Appl. No.: 11/782,524

(22) Filed: Jul. 24, 2007

Related U.S. Application Data
(60) Provisional application No. 60/820,733, filed on Jul. 28, 2006.

(51) Int. Cl. H04L 12/26; H04L 12/24; H04Q 7/00

(52) U.S. Cl. 370/217; 370/222; 370/258; 370/331

(57) ABSTRACT

A wireless communications network topology and its implementation enable the wireless network implementing the topology to be sufficiently robust to avoid or mitigate the consequences of various node failures. The inventive network topology includes a triangular ring mesh, preferably constituting a flower topology in its entirety. For each node in a given layer of stations, at least two links are provided, one to each of two selected nodes in an adjacent layer of stations.

### FIELD OF THE INVENTION

The invention herein described relates generally to a method and apparatus for supporting data communications between individual users of communicating digital devices by means of a network that provides wireless connections to such users and to an internet gateway. Such communicating digital devices include portable computers, pocket personal computers (Pocket PCs), personal data assistants (PDAs), cellular telephones, and the like.

### BACKGROUND OF THE INVENTION

Wireless networking continues to develop, partly as a result of deregulation of the telecommunications regulatory structure and the continuing convergence of telecommunications and computing. Increased availability of high-speed computer processors (and accompanying higher data transmission speeds) and relatively low power requirements have made it possible for relatively weak signals in a noisy environment to be received and detected and their intelligence recovered. Indoor wireless networking is quite common, utilizing for example HomeRF® or Bluetooth® standards or protocols. Yet prior indoor wireless systems tend to be limited in terms of data transmission rate (typically 1 to 2 Mbps), power (100 mW) and range (no more than 100 ft). Interest in wireless networking has increased lately as engineers and technicians consider methods of implementing wireless networks which surpass the limitations of prior indoor networks. Proposals have been made for wide-area wireless network spanning a municipality or a large geographical area (both indoor and out). Objectives of such proposals include provision of internet access and internet-bundled services to mobile and fixed users, without the need for installation of hard-wired infrastructure such as optical fibre or high-speed cabling.

While routing and control commands and associated hardware and software are not per se a part of the present invention, it is useful for the network designer to have in mind some of the basics of routing and control. The Dynamic Host Configuration Protocol (DHCP) is an evolving standard protocol or set of rules used by communications devices such as a computer, router or network adapter to allow the device to request and obtain an IP address from a server which has a list of addresses available for assignment. In a network context, DHCP is used by networked client computers to obtain IP addresses and other parameters such as the default gateway, subnet mask, and IP addresses of DNS (Domain Name System) servers from a DHCP server. It facilitates access to a network because these settings would otherwise have to be made manually for the client computer to participate in the network.

The assignment of IP parameters occurs when the DHCP-configured client computer boots up or regains connectivity to a network. The DHCP client sends out a query requesting a response from a DHCP server on the locally attached network. The query is typically initiated immediately after booting up and before the client initiates any IP-based communication with other hosts. The DHCP server then replies to the client, communicating its assigned IP address, subnet mask, DNS (Domain Name System) server and default gateway information.

The DHCP server ensures that all IP addresses are unique, i.e., no IP address is assigned to a second client while the first client's assignment is valid (its lease has not expired). Thus IP address pool management is done by the server and not by a human network administrator.

In computer networks, a subnetwork or “subnet” means either (i) a selected range of logical addresses within the address space that is assigned to an organization; or (ii) the physical counterparts of the selected addresses. Subnetting involves a hierarchical partitioning of the network address space for a controlled network and associated network nodes of an autonomous system into two or more subnets. Routers constitute borders between subnets. At a given node, communication to and from a subnet is mediated by one specific port of one specific router, at least transiently.

A typical subnet is served by one router, for instance an Ethernet network (consisting of one or several Ethernet segments or local area networks, interconnected by network switches and network bridges) or a Virtual Local Area Network (VLAN). However, subnetting allows the network to be logically divided regardless of the physical layout of a network, since it is possible to divide a physical network into several subnets by configuring different host computers to use different routers.

Subnetting simplifies routing, since each subnet typically is represented by one row in the routing tables in each connected router. At each station of a network, the computer, working with two or more network interface controllers (NICs), has to “look at” its routing table to determine the interface through which to send each IP packet that is processed through the station. Absent arrangements for default routing, if the routing table does not contain an entry that matches the packet's destination address, it will be discarded with a “no route to host” error message.

If there are no subnets and there is only one NIC at the station, and if the IP packet destination address is in the routing table, there is no problem; the packet is automatically directed to that address. If there are two subnets and the station is on the same subnet as that to which the packet is destined, again there is no problem, because the routing is within the routing table for that subnet. In many instances, a routing destined to an address in some other subnet is sent to the gateway address of the default route set for no-address routing table listings, instead of discarding the message and sending a “no route to host” error message. Once the data packet enters that default route, it may encounter a station having the destination address in its routing table.

The Institute of Electronics and Electrical Engineers (IEEE) began to draft standards for the implementation of hard-wired Local Area Networks (LANs) in 1980. These standards, known as IEEE 802, eventually became more specific for certain aspects of LAN implementation. The IEEE 802 standards follow the Open System Interconnection (OSI) model approved by the International Standards Organization (ISO) and International Telecommunication Standardization Union (ITU-T) in ISO/IEC 7498-1 (1997). IEEE 802 specifications are focused on the two lowest layers of the OSI model because they incorporate both physical and data link components. All 802 networks have both a Media Access Control (MAC) and a Physical (PHY) component. The term “PHY” is used to identify the physical layer through which wireless transmission takes place. The PHY layer is also referred to as layer 1 or the Air Interface. The term “MAC” refers to a set of rules to determine how to access the medium and send data, while the details of transmission and reception are left to the PHY layer. While IEEE 802 primarily concerns standards relating to the overview and architecture of the LAN, other specifications in the 802 series address other aspects of the LAN. IEEE 802.1 concerns management of the LAN, including provisions for bridging (802.1D) and virtual LANs or VLANs (802.1Q). IEE 802.2 specifies a common link layer, the Logical Link Control (LLC), which can be used by lower-layer LAN technology.

IEEE 802.11 is another link layer that makes use of the 802.2/LLC encapsulation. The base 802.11 specification includes the 802.11 MAC and two physical layers: a frequency-hopping spread-spectrum (FHSS) PHY layer and a direct-sequence spread-spectrum (DSSS) link layer. Media access control packet data units (MPDUs) are transmitted in on-air PHY slots. Within these MPDUs, MAC service data units (MSDUs) are transmitted. MSDUs are the packets transferred between the top of the MAC and the layer above. MPDUs are the packets transferred between the bottom of the MAC and the PHY layer below.

Later revisions to the standards add other PHY layers to the 802.11 specification, including: orthogonal frequency division multiplexing (OFDM in IEEE 802.11a); high-rate direct-sequence spread-spectrum (HR/DSSS in IEEE 802.11b); and Extended Rate PHY layer (ERP in IEEE 802.11g). Thus IEEE 802.11a is compatible with the use of a transceiver operating at 5.7 GHz, OFDM, FHSS and a data bit rate of 54 Mbps, while an IEEE 802.11b-compliant a transceiver may operate at 2.4 GHz, DSSS and a bit rate of 11 Mbps. IEEE 802.11g is an attempted compromise between IEEE 802.11a and IEEE 802.11b; IEEE 802.11g contemplates the use of eleven to fourteen channels, three of which overlap, a narrower bandwidth, the 2.4 GHz band and a bit rate of 22 or 33 Mbps (depending on whether it uses Packet Binary Convolutional Coding or Complementary Code Keying OFDM). Frequencies used may vary depending upon regulatory requirements in certain countries. Generally most wireless data communication devices conform to at least one of these standards in order to maintain interoperability. IEEE 802.11b is preferred over IEEE 802.11a because it can accommodate greater bit rates and is less susceptible to multipath distortion of signals due to its use of DSSS over OFDM. IEEE 802.11b devices have only relatively recently become commercially viable with legislative deregulation of the 5 GHz band and developments in semiconductor technology. At the present time, improved standards in the 802.11 family are being developed.

In order to implement a wireless network, one approach is to consider the overall network as comprising four subsystems: architecture; routing; capacity and throughput; and beam forming and wireless signal transmission and reception (antennae and transceivers). All of these subsystems are inter-related and the design of any one subsystem will influence the performance of the others. Generally routing and capacity and throughput are handled by off-the-self software, such as LocustWorld®, MeshAP®, GNU® Zebra, Ad hoc On Demand Distance Vector (AODV), MikroTik™ Router Operating System, or Mitre MOBILEMESH®. At least some antenna requirements can typically be met by off-the-shelf hardware.

Suitable selected software controls network traffic or re-routes it as the network becomes congested or parts of it break down. Re-routing commands may be centralized, or may be somewhat decentralized. Network synchronization can be achieved through the use of Global Positioning Satellite (GPS) receivers throughout the network, in that the GPS provides a highly accurate clock signal which can be used by all or some of the network nodes. Yet routing can be made more efficient by the design of the network architecture (nodal interconnections). The network architecture can be built by careful placement of antennae and the use of directional antennae. In some instances, antenna polarization might be used to minimize interference. The antennae may then be hooked up to multi-mode radio transceivers, such as the Atheros® Communications AR5002X series (and in particular the AR5212) to extend the network through the use of repeaters or to allow transmission of signals on different bands through the use of transverters. Transceivers, such as the Atheros® AR5212, and the flow of MSDUs through the network are typically controlled by software; for example, MikroTik™ Nstreme protocol is one of a number of protocols available for controlling transceivers, while the overall network traffic may be controlled, for example, by the MikroTik™ Router Operating System v.2.8. Such software may not only control signal flow through the network but may also prioritize MSDU traffic so that delay-sensitive applications, such as Voice-over-Wireless internet protocol (IP) and Streaming Multimedia MSDUs over MSDUs that are not delay-sensitive, such as e-mail traffic in accordance with Quality of Service standards such as IEEE802.11e and the WiFi Alliance WMM™ Scheduled Access standard.

The IEEE family of 802.11 standards relating to architecture of a network, or its “mesh”, are currently under development by the IEEE Computer Society/Local and Metropolitan Area Networks task group. IEEE is not expected to approve such standards until 2008. At the moment, two competing architectures are vying for the IEEE 802.11 s standard: SEEMesh (short for Simple, Efficient and Extensible Mesh) and Wi-Mesh (short for Wireless Mesh). SEEMesh is backed by companies such as Motorola and involves the use of a cellular hexagonal network applied to wireless networks. Motorola calls it CANOPY®. A combination of network connections between nodes of similar types (“peer-to-peer”) and between such nodes and nodes at different levels in the hierarchy of nodes or stations is used. Wi-Mesh is backed by companies such as Mitre and involves the use of hopping between nodes and minimization of the number of hops through constant monitoring of the network by each node so that the shortest distance to an internet gateway is always known and routing can be directed accordingly. In Wi-Mesh, there is no hierarchy of nodes; the nodal connections are of similar peer-to-peer types, and the network is distributed.

In a local wired context, the RFC studies reflected in IETF RFC1519 “Classless Inter-Domain Routing (CIDR): an Address Assignment and Aggregation Strategy” (September 1993); IETF RFC 1631 “The IP Network Address Translator (NAT)” (May 1994); and IETF RFC 2766 “Network Address Translation—Protocol Translation (NAT-PT)” (February 2000), are of interest. However, these documents do not teach apparatus nor methodology that usefully contributes to the robustness of a wireless network.

In any telecommunications network, there can be a failure of a node or of a communications link between nodes. This problem is acute in the context of cellular telephony, as the location of a given cellphone may vary significantly even in the course of a single call. When the link being used becomes problematic and the signal fades, handoff or roaming may occur to re-establish an effective link. The terms “handoff” and its equivalent “handover” refer to the process of transferring an ongoing call or data session from one channel connected to the core network to another, typically within the ambit of the same service provider. In satellite communications, it is the process of transferring satellite control responsibility from one earth station to another without loss or interruption of service, this being necessary by reason of travel of the satellite and/or rotation of the earth. There may be different reasons why a handoff (handover) might be conducted, such as movement of a cellphone from the area served by one cell into an area covered by another cell. An ongoing call is transferred to the second cell in order to avoid call termination when the cellphone is outside the range of the first cell. Handoff can also occur in other situations, such as when the channel used by the cellphone runs into interference with another cellphone using the same channel in a different cell. The call may be transferred to a different channel in the same cell or to a different channel in another cell in order to avoid the interference.

The concept of handoff is close to the concept of roaming. “Roaming” is a general term in wireless telecommunications that refers to the extending of connectivity service to a location that is different from the home location for a given communicating device such as a cellphone. Roaming occurs when a subscriber of one wireless service provider uses the facilities of another wireless service provider. This second provider typically has no direct pre-existing financial or service agreement with this subscriber to send or receive information. Roaming is likely to occur when the home service provider's signal is too weak or if the number of active callers is too high.

The so-called SEEMesh network design approach is an application of a network topology imported from the mobile communications industry, especially those topologies for cellular telephone networks. In applying mobile communication network topologies, designers frequently work on the assumption that the technical issues of concern for the design of mobile communications networks are essentially the same as the technical issues for the design of wireless data communications networks. While the problem of roaming stations is common to both types of networks, the problem of drop-out of signals is not. Perhaps the most serious problem incidental to a mobile communication network is the occasional inability of a roaming station to make contact with a base station. By contrast, a more serious problem incidental to a data communication network, having an internet link, is the loss of the wireless interconnection between an internet gateway and an access point. The loss of connectivity to a data communication network by a user may not be catastrophic, in that the user may simply reposition the wireless device for better reception. On the other hand, the loss of connectivity to an internet access gateway may be catastrophic, because all users dependent upon that connection will be adversely affected. In the mobile environment, such a loss would be equivalent to a base station losing its connection to the Public Switching Telephone Network (PSTN). Such a problem is rare in the experience of mobile communications network designers, because the connection of the base station to the PSTN is typically hard-wired. By contrast, the access point to a backhaul station (where the internet gateway is located) is a wireless connection in wireless data communications networks. Such connection is intended to be wireless, because one of the aims of the wireless network is to avoid the need for installation of hard-wired infrastructure to as great an extent as feasible. The undesired loss of connectivity to an internet gateway is a serious event and its consequences should be minimized to the extent reasonably possible. Simply applying a given mobile communication network design to wireless data communication network design is therefore unlikely to be a satisfactory solution, particularly with respect to compensating for anticipated failures of network nodes.

The Wi-Mesh approach to wireless network design attempts to minimize the number of hops between access points and backhaul stations by having each access point in a wireless network monitor its local network structure and identify the shortest path from itself to a backhaul station having internet access. This approach is not directed to the design of the network topology itself. Wi-Mesh is superior to SEEMesh to the extent that it departs from mobile communications network design, yet it presumes that multiple hops are inevitable. Multiple hops, even if their number is minimized, can still lead to traffic congestion in the network. Wi-Mesh is an approach to optimizing an ad hoc network. (An “ad hoc” network architecture or protocol is one designed to meet specific layouts or requirements, as distinct from preconceived architectures or protocols to which the network must conform.) There is no particular design to the architecture or the construct of the topology other than it already exists. Wi-Mesh incorporates no network topology design and aims only to optimize network routing and traffic in a given ad hoc network.

Simply applying mobile communication network design (as in SEEMesh) to wireless network design is neither efficient nor cost-effective. While Wi-Mesh represents a departure from prior mobile communication network design, it does not take into account network architecture, because it concerns itself with ad hoc network topology. There exists a need for a wireless mesh implementation that takes into account: architecture; routing; capacity and throughput; and, as to apparatus, antenna design and beam forming. Further, there exists a need to accommodate any suitable such implementation to an urban built-up environment.

For further information to round out the general state of the art, the reader may consult: Matthew S. Gast, 802.11 Wireless Networks: The Definitive Guide (Sebastapol, Calif.: O'Reilly, 2005); ANSI/IEEE Std 802.11, 1999 Edition; Motorola CANOPY® technical manuals at: http://motorola.canopywireless.com/; MikroTik™ brochures and product specifications at: http://www.mikrotik.com/; Senza Fili Consulting, “Wi-Fi Mobile Convergence: The Role of Wi-Fi CERTIFIED®” (Wi-Fi Alliance, April 2006); IETF RFC 3979, “Intellectual Property Rights in IETF Technology” (March 2005); IETF RFC 1752, “The Recommendation for the IP Next Generation Protocol” (January 1995); IETF RFC 2460 “Internet Protocol, Version 6 (IPv6) Specification” (December 1998); U.S. Pat. No. 5,517,618 (Wada et al.) filed on 8 Feb. 1993; IEEE, Wikipedia (IEEE 802.11); VNU Network Article “Wi-Mesh Standardisation Process Begins: IEEE to Hammer Out 802.11 s Standard” (20 Jul. 2005); see also websites of LocustWorld, MITRE and Motorola and http://www.pcw.co.uk/articles/print/2140110; also Steven Cherry, “Wi-Fi Nodes to Talk Amongst Themselves,” IEEE Spectrum (July 2006) at: www.spectrum.ieee.org/print/4114).

### SUMMARY OF THE INVENTION

The present invention is not unitary but embraces a number of novel aspects of network design and methodology, and a number of apparatus-related aspects of its implementation. Reference to the “invention” should be understood as embracing the entirety of the inventive concepts and their implementation as well as subsets of thereof, or a selected subset or subsets, as the context may require.

In this specification and in the appended claims, “network” includes a subnetwork (subnet) unless the context otherwise requires. In other words, the principles of the present invention may be applied to a given network as a whole, or to one or more selected subnetworks within it. A network is made up of linked stations. “Linked” implies either an active link or an available link that is redundant as long as the active link is functioning satisfactorily. Typically default links are established to interconnect linked stations; alternate links, redundant while the active link is operative, may be selected for use in the event of node or link failures or in response to traffic conditions or for other reasons. When stations in two layers are “redundantly linked”, this implies that there are at least two available links from a station in one layer to stations in an adjacent layer. One of these links is typically a default link with one station in the adjacent layer that is normally operative, and the other of the links, sometimes referred to as the redundant link, is with some other station in the adjacent layer, and may be normally idle for the purposes of connecting the stations in the two layers. This redundant link may become active in certain conditions, such as the failure of the normally active default link. Through the use of router and relay methodology, links may be substituted or extended. A network whose links are replaced or extended by other links, some of which come into existence as a result of router and relay operations, may be considered to be in whole or in part a “logical network”. The basic design principles of the present invention can be applied to such logical networks.

In this specification and in the appended claims, “station” includes not only control stations, backhaul stations, access point stations, etc. but also may include a gateway, relay, or a connectivity point or other point to which a communications link can be made (including internet or intranet connectivity). The term “link” or “signal path” or the like includes a wired link as well as a substituted or extended link. However, the principal application of the basic design principles of the present invention is intended to be to networks that are entirely or in preponderance wireless, and it is in a wireless context that the principal advantages of the present invention arise. For example, “handoff” (“handover”), “failover” and “roaming” are operations of significance in wireless networks to which the present invention applies, but have little or no significance in the context of completely wired networks. “Failover” in this context is the capability to switch over automatically to an alternate or redundant or standby link upon the failure or abnormal termination of operation of the previously active link or node.

The terms “layer” and “level” are used in this specification to identify groups of stations having similar functions in a given network. The term “hierarchy” is used to identify the various layers in order of access of stations to one another, with the station(s) having the highest level of control of the network being at the top of the hierarchy. For example, one may consider a central control station to be at the highest level in a given network, a group (“layer”) of backhaul stations each connected to the central control station to be at the next level in the hierarchy, and at the lowest level of the hierarchy, a group (“layer”) of access point stations each connected (in accordance with the inventive topology) to at least a pair of the backhaul stations. (In most or many networks, the access point stations would not have a direct link to the central control station; a linked backhaul station would normally intervene between the central control station and any given access point station.) The terms “layer”, “level” and “hierarchy” should be construed liberally and not rigidly in this specification and the appended claims. There may from time to time be functional changes at a given station that require some adjustment in one's thinking about its place in the hierarchy; for example, under certain conditions, it may be required that a backhaul station assume the functions, at least temporarily, of a central control station. The inventive topology is intended to facilitate maintaining adequate connectivity between stations in adjacent levels or layers in the event of link or node failure, without requiring undue hopping. That objective and the implementation described herein can be extrapolated to inter-station links that do not precisely fit the usual “layer”, “level” and “hierarchy” nomenclature, and may apply in circumstances in which one or more stations assume some or all functions of a station or stations at a different level in the hierarchy.

The present invention in one aspect is a novel wireless network based on novel topological design principles, and means for its implementation. A principal objective of the design of the inventive network topology is to limit the impact on the wireless network of a failure of a node or a normally operative nodal link to another node or station, including an internet gateway. Of principal concern is failure of internodal connections at higher levels in the hierarchy of nodes or stations. In the event of such failure, or in the event of the need to switch to an alternate link because of traffic conditions in the network, etc., failover is facilitated because of the robust character of networks that implement the inventive topology. Fulfilment of these objectives tends to limit the increase in message traffic congestion throughout the network that is consequent upon the failure of a node or link or upon increased local traffic. These design objectives are achieved through the exploitation of limited diversity and redundancy of peer-to-peer and point-to-point nodal links, and preferably configuring the network according to a flower topology selected in accord with the general principles of the invention while taking into account the area served, traffic density and number of expected users.

Preferred flower topologies according to the invention comprise interconnected triangular meshes with redundant links between interconnected stations. The redundancy, coupled with conventional handover technology, enables an alternate redundant link to a sought node or station to become operative in the event that a default link becomes inoperative or temporarily disabled because of traffic conditions or the like. Accordingly, a redundant link brought into operation is no longer redundant but becomes the operative link in the applicable part of the network, at least temporarily. For example, in a simple such topology, AP stations are linked to one another and to associated BHSs; BHSs are linked to one another and to associated AP stations. Each AP station is linked to two different BHSs, thereby forming a mesh of unique triangular networks. Equally, each BHS is linked to two different AP stations, thereby forming a mesh of unique triangular networks. Because each AP station is linked to two different BHSs, if one link fails, in the ordinary case, the other link will continue to be operative, so no hopping will be necessary to maintain network connectivity throughout. While a given AP station could be linked to more than two BHSs, the disadvantage of added complexity may offset any appreciable extra “insurance” obtained by having one or more extra links.

In one aspect, the invention provides a network structure that facilitates traffic shifting when an internet gateway fails. In that event, the backhaul station (if it is still operational) may simply relay message traffic to another backhaul station with an internet gateway, along its peer-to-peer data links. Alternatively the backhaul station (if it is still operational) may return the message to the originating access point (in a point-to-point and hierarchical network nodal communication) and command the access point to divert that message and all further messages via the access point's alternative backhaul station link until further notice. Alternatively (if the backhaul station and internet gateway are both non-operational) a command may be routed from another network traffic controlling station via the alternate backhaul station or via adjacent access points to the access point of concern, instructing that all traffic be routed through the alternative backhaul station until further notice or until repairs are reported. Alternatively the access point may be able to detect the failed backhaul station link on its own and switch to an alternate link. Preferred embodiments of the invention enable all of the foregoing modes to be operational in the appropriate circumstances. Routing under direction from various monitoring nodes may be utilized to optimize, to the extent possible, traffic flow throughout the partially failed network.

In a general sense, another aspect of the invention is the provision of robust wireless communications links failover protection by applying the principle of link redundancy either to all nodes in a given wireless network, or to all the nodes in a subnetwork thereof that are deemed sufficiently critical that they require failover protection. The simplest and most reliable design approach in this connection is to provide failover protection throughout the entire network. Failover should be designed to occur automatically without human intervention.

Another way of looking at the redundancy/failover principle of the present invention in a subnetwork context is to observe that subnetworks may be considered as physical entities but they may also be considered as logical entities. Nodes in the physical entities are wirelessly interconnected in accordance with a preferred topology, as discussed above. But from a logical point of view, a subnetwork may comprise nodes that are interconnected via routers to a variable selection of other nodes. As mentioned previously, it is possible to divide a physical network into several subnets by configuring different host computers to use different routers. In such latter cases, the “logical topology”, or more precisely the logical analogue of topology, should be, for each subnet or at least for selected subnets, the logical equivalent of a triangular-mesh topology. This implies that there should be at least two available links between a given station at one hierarchical level and immediately available stations at the next level (up or down, as required). Looking at logical subnetworks, one simply applies to a logical structure (or to the possible variants thereof) the logical equivalent of a preferred triangular mesh topology according to the invention. If this approach is taken, then failover in the logical subnetwork can be automatically implemented without difficulty.

The topology of the invention can support, in a wireless-link network, preferred methodology and equipment choices, preferably in all AP stations and all stations at higher levels in the network, to facilitate optimization of roaming, handover and failover in the event of a link failure or changed link preference (e.g. because of traffic congestion or weak signal). In preferred embodiments of the invention, these objectives are implemented as follows:
1) At each station or at designated stations, a suitable unman (i.e., unmanaged) router is installed or modified to select the operative connections to the station's critical links with other stations in the network and with other needed service providers, e.g. internet host service providers.
2) Signal routing may in some cases be selected to occur between two (or more) distinct subnets within the network. In such cases, a DHCP server is selected and configured to provide internet addresses to one or more of the subnets.
3) Failover redundancy in accordance with the principles of the invention is provided within each such subnet within the network.
4) Since some links may be wired rather than wireless, e.g. links to internet service providers, the foregoing objectives should be achievable (i) within either wireless or wired subnets; and (ii) whenever one or more wired links are used by a given station.

Message traffic peer-to-peer hopping between access points will significantly increase traffic congestion and slow down or disrupt a network. While it is an option for rerouting in the event of a backhaul station's failure, access point hopping is not desirable because hopping adversely affects the network. Like the CANOPY® design, the present invention makes use of distributed network services and peer-to-peer (or backbone) nodal connections between nodes of the same type, but unlike CANOPY®, the present invention intentionally makes limited use of nodal links from one node to another node in the network hierarchy. Unlike CANOPY®, access point hopping is not the initial default method of re-routing of messages; it is avoided through the use of alternate linking to another backhaul station. In instances of multiple and adjacent backhaul station failure, access point hopping may be unavoidable, but unlike CANOPY® design, network design incorporating flower topology according to the invention either eliminates or restricts access point hopping, thus mitigating the effects of nodal failure on the network as a whole. Whereas the optimal functioning of a CANOPY® network depends upon active users (customers) whose wireless devices serve as relay-station nodes in the network, the robustness of wireless networks according to the present invention is independent of whether any given customer or group of customers is logged into the network or not.

A preferred implementation of flower network topology according to the invention involves the use of both omnidirectional antennae and directional antennae whose location is carefully selected within the wireless environment. These antennae are connected to conventional transceivers, amplifiers and transverter units as required, in accordance with conventional practice. Especially in built-up areas or areas in which there are significant obstructions, the coverage and aiming of antennae has to be carefully considered and selected.

In preferred implementations of the invention, transceivers, transverters, repeaters, portable computers, logic circuits and associated controlling circuitry, all of which may be of conventional design or routine adaptations of conventional design, are mounted in weatherproof containers and mounted in close proximity to their antennae in order to reduce cable transmission losses and avoid external interference from proximate utilities such as power lines. The devices within such containers may be powered by standard mains supplies, or, especially in remote locations, by batteries recharged by non-conventional means (including wind or solar energy sources). Especially in an urban environment, these containers and associated antennae may be mounted on street lamps, utility poles or other prominent objects in order to provide local coverage and make cost-effective use of existing infrastructure. Containers and antennae may be camouflaged for aesthetic reasons. Antennae are preferably placed far enough from utility services to avoid interfering signals from adjacent utility services, including those from hardwired data transmissions through Broadband Power Line (BPL) or Power Line Communications (PLC); noise within discrete discernible bandwidths may be filtered out.

Networks designed according to the invention are capable of supporting suitable microprocessor management of the routing of data packets through the various backbone links and nodal hierarchies, but such management is not per se part of the present invention.

Preferred implementations of the invention are expected to provide platforms for relatively high reliability and speed of digital communication. Preferred designs of wireless networks in accordance with the invention are expected to be relatively robust in that they are capable of providing suitable alternative signal paths and node connections in response to temporary loss of service of one or more signal paths or network nodes.

According to another aspect of the invention, several flower network topologies may be interconnected to provide very large geographical coverage of an entire network area. In other words, networks according to the invention are scalable. Preferred designs are expected to be suitable for use in large built-up areas.

In a preferred embodiment of the invention, the network provides wireless computer internet access and the availability of a full suite of internet bundled services including internet browsing, e-mail messaging, streaming audio and video, telephony, intelligent transportation systems (ITS), emergency services reporting, traffic and parking enforcement, real-time tracking, etc.

By suitably designing the network as recommended above, failover protection may be implemented by a suitable combination of routing and processing equipment operating under the control of suitable selected software. The selection of such equipment and software is in the discretion of the network designer, and would be expected to be made on the basis of empirical considerations and on the kind and complexity of the network under consideration. The present invention is directed to the provision of network topology and antenna/radio/router arrangements in general that can serve as foundation selections that will be complemented by the designer's selection of routing and processing equipment and associated software. The present invention is not directed to such latter selections.

The application of the foregoing failover protection capability to a complex network having various levels of nodes and links in a network control hierarchy enables the implementation of multipath links serving multiple signals to or from stations at different levels in the hierarchy, with failover protection throughout. Further, with suitable antenna selection, a small antenna footprint can be made available without sacrificing communication efficiency. With suitable design selection of router, data packet header, processors, radios, etc., the antenna can serve several radios/signals concurrently, the data signals being kept separate from one another by means of suitable header information in the packets and through suitable routing of packets under the control of such header information. With suitable antenna selection, roaming or handoff can be accomplished by suitable programming of the processors/routers to select communications paths and links that are operative and to reject those that are inoperative.

Although preferred embodiments of network links according to the invention are described herein for the most part as being wireless, it is open to the designer to substitute a hard-wired link for a wireless link in virtually any part of networks that embody various aspects of the present invention. Substitution of wired links for wireless links is in the discretion of the designer; various aspects and principles of the invention as described herein may still be implemented in networks including one or more such substitutions. Such partially wired networks are within the scope of the invention.

### SUMMARY OF THE DRAWINGS

All of the drawings are schematic drawings and are not to scale.

FIG. 1 is a schematic diagram illustrating the components making an Basic Service Set (BSS), in the IEEE 802.11 standard and therefore represents prior art.

FIG. 2 is a schematic diagram illustrating the components making up an Extended Service Set (ESS) in the IEEE 802.11 standard and therefore represents prior art.

FIG. 3 is a schematic diagram illustrating a wireless wide local area network (WWLAN) in the IEEE 802.11 standard and therefore represents prior art.

FIG. 4 is a schematic diagram illustrating a linear network known in the prior art.

FIG. 5 is a schematic diagram illustrating a triangular ring network known in the prior art.

FIG. 6 is a schematic diagram illustrating a ring network known in the prior art.

FIG. 7 is a schematic diagram illustrating a star network known in the prior art.

FIG. 8 is a schematic diagram illustrating a mesh network known in the prior art.

FIG. 9 is a schematic diagram illustrating a cluster of rings network known in the prior art.

FIG. 10 is a schematic diagram illustrating a hybrid network, which may be known in the prior art.

FIG. 11 is a schematic diagram illustrating an exemplary mounting of an antenna configuration and equipment on a power utility pole, known in the prior art.

FIGS. 12 through 17 are schematic diagrams respectively illustrating different antenna configurations that can be used to implement wireless connections shown in FIGS. 1, 2 and 3 and to implement any of the networks shown at FIGS. 4 through 10. They are each therefore prior art per se. In particular:

FIG. 12 is an illustration of an antenna configuration consisting of an omnidirectional antenna and two directional Yagi antennae.

FIG. 13 is an illustration of an antenna configuration consisting of an omnidirectional antenna and a directional parabolic antenna.

FIG. 14 is an illustration of an antenna configuration consisting of an omnidirectional antenna and three-directional sector antennae.

FIG. 15 is an illustration of an antenna configuration consisting of an omnidirectional antenna and two pairs of downtilted directional sector antennae.

FIG. 16 is an illustration of an antenna configuration consisting of an omnidirectional antenna and a directional parabolic antenna and one pair of downtilted directional sector antennae.

FIG. 17 is an illustration of an antenna configuration consisting of an two directional parabolic antennae.

FIG. 18 is a pair of equivalent schematic diagrams illustrating the access-point architecture of the Motorola CANOPY® network design, known in the prior art.

FIG. 19 is a schematic diagram illustrating a Motorola CANOPY® mesh, known in the prior art.

FIG. 20 is a schematic diagram providing an illustration of the effects of the failure of one access point in the Motorola CANOPY® design, identifying a limitation that the inventive flower network seeks to mitigate or avoid.

FIG. 21 is a schematic diagram providing an illustration of the effects of the failure of two adjacent backhaul stations in the Motorola CANOPY® design, and identifies a limitation that the inventive flower network seeks to mitigate or avoid.

FIG. 22 is a schematic diagram providing an illustration of the effects of the failure of peripheral backhaul stations in the Motorola CANOPY® design, and identifies a limitation in that design that the inventive flower network seeks to mitigate or avoid.

FIG. 23 is a schematic diagram of part of an exemplary network embodying flower topology according to the present invention.

FIG. 24 is schematic diagram of a network embodying flower topology in an exemplary preferred embodiment of the invention.

FIG. 25 is a schematic diagram providing an illustration of the effects of failure of one backhaul station in a network embodying the inventive flower topology.

FIG. 26 is a schematic diagram providing an illustration of the effects of failure of two adjacent backhaul stations in a network embodying the inventive flower topology.

FIG. 27 is a schematic diagram illustrating part of a scaled-up network embodying the inventive flower topology shown in FIG. 23.

FIG. 28 is a schematic diagram illustrating a scaled-up flower-topology network according to an embodiment of the invention, comprising sub-networks each embodying flower topologies according to the invention.

FIG. 29 is a schematic diagram illustrating part of a variant of a network embodying the inventive flower topology in accordance with another embodiment of the invention.

FIG. 30 is a schematic diagram illustrating a network embodying the inventive flower topology, of the type of which FIG. 29 illustrates a part.

FIG. 31 is schematic diagram illustrating a network embodying the inventive flower topology, resembling that of FIG. 24 but excluding the central controlling office and its links to backhaul stations.

FIG. 32 is a schematic elevation view of an antenna mast and associated telecommunications equipment suitable for use in a multipath implementation of the present invention.

FIG. 33 is a schematic top view of the antenna mast and associated telecommunications equipment of FIG. 32.

FIG. 34 is a schematic view of a router and its connections to radios (or radio links) suitable for use with the multipath antenna of FIG. 32.

FIG. 35 is a schematic diagram representing a composite of three interconnected networks or subnetworks, each conforming to the topology of FIG. 24.

### DETAILED DESCRIPTION

This description makes use of terminology, including abbreviations, that are defined and used in discussions of wireless networks compliant with IEEE Standard 802.11, but it is not mandatory, in order to make use of the invention, that strict adherence to IEEE standards be observed. Reference may be made generally to industry literature relating to such networks to obtain a basic understanding of the terms used to identify network components, architecture, subsystems, etc.

The invention makes use of apparatus and methodology known in the art. A brief discussion of known wireless systems, topologies, methodology and apparatus precedes a discussion of the invention per se. Reference to “the invention” includes reference to the whole or any part of the inventive systems, topologies, methodology and apparatus, as the context requires.

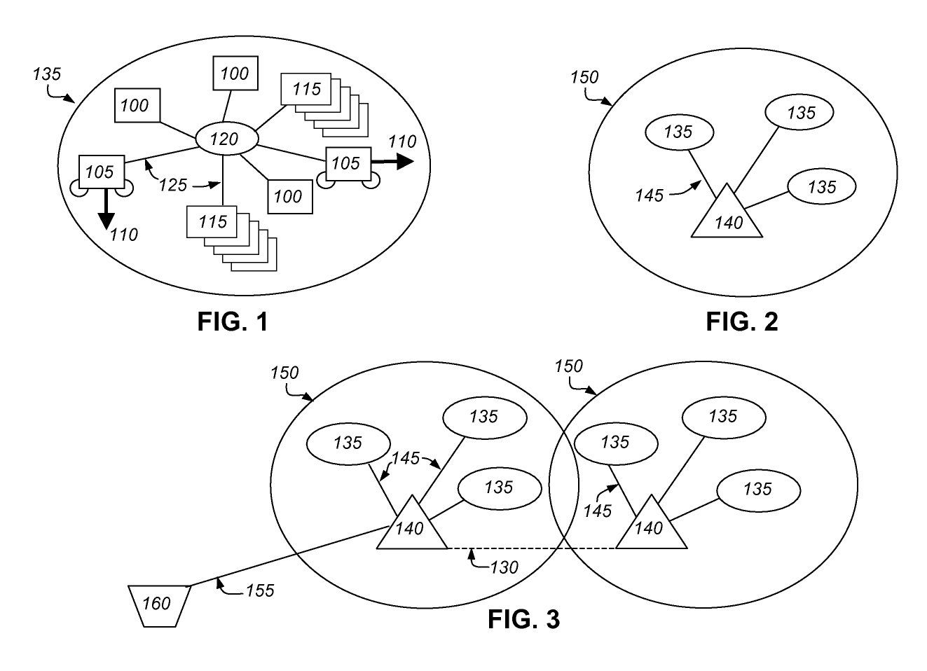

FIG. 1 illustrates the concept of the Basic Service Set (BSS) 135, defined in IEEE Standard 802.11. (In FIGS. 1 to 3, the outer ovals surrounding sets of component elements are notional and do not correspond to any particular physical reality.) Sometimes this arrangement is described as a point-to-multipoint setup. Stations 100 communicate with a BSS Central Coordinating Station (BSS CCS) 120 via communications links 125 that normally make use of the wireless medium (WM) between stations 100, stylized in FIG. 1 by a line. In other words, the WM supports a set of links 125 by which each of the stations 100 is wirelessly coupled to the BSS CCS 120. In this specification and accompanying drawings, such lines illustrating wireless links imply a normally operative coupling; this in turn implies that the linked stations are sufficiently proximate to one another that the wireless link works for them at normal transmission power. For the most part, such links are referred to herein as such and not as “wireless medium” or “WM”. The BSS CCS 120 in conjunction with the stations 100 and their links thus establish a Distribution System (DS). It is possible for one or more mobile stations 105, travelling with motion vector 110, to operate within the BSS 135. A fixed LAN station 115 is also shown in FIG. 1, the successive staggered boxes representing individual stations hardwired to the fixed LAN station 115. The interface between the WM and any hardwired fixed LAN station 115, is called a portal or gateway. Thus a fixed LAN station 115 will interface with the WM through its portal rather than directly with the BSS CCS 120. Generally the interface between any of the stations 100 and the WM is not called a portal, since there is only one station 100 involved, as distinct from the multiple stations associated with a hardwired fixed LAN station 115. The interface between the WM and the BSS CCS 120 is also called a portal. The aggregate of all elements in FIG. 1 constitutes the Basic Service Set (BSS) 135. For any given BSS, a BSS CCS station 120 interconnects all stations 100, 105 and 115. BSSs may be suitably coupled together in a network, e.g. the rather simple Extended Service Set (ESS) network described below with reference to FIG. 2.

Typically the RF output from each of the stations 100, mobile stations 105, and fixed LAN stations 115 will be in the range of 100 mW at 2.4 GHz from an omnidirectional antenna. A directional antenna (Yagi, parabolic or sectoral) may be used for any given fixed station, especially if attenuation or obstacles occur in available paths of propagation, or if the area of coverage is to be limited both in terms of sector or in terms of distance (the area of coverage may be constrained through downtilting of antennae). An omnidirectional antenna is preferred at the BSS level so that if the data communications link from any given station to the BSS CCS 120 fails, the station may roam and seek an alternate BSS CCS 120 from an adjacent BSS 135. An omnidirectional antenna may also be preferred because portable and mobile stations 115 may be located anywhere around the 360° sector of coverage. It is possible however that only a portion of that 360° is to be covered, in which case a sector antenna may be preferred. Further, instead of an omnidirectional antenna it may be desirable in some instances to provide an array of sector antennae about a central mounting pole, the sector antennae beams separated by roughly equal angular distances (say, four sector antennae each occupying a discrete 90° sector) and each beam spanning a selected angular range (say, 30°). The use of an array of sector antennae improves the efficiency of the signal transmission as compared to an omnidirectional antenna.

FIG. 2 illustrates an exemplary Extended Service Set (ESS) 150 of the type defined in IEEE Standard 802.11. The ESS 150 is an aggregate network comprising a number of BSSs 135 each connected to and controlled by a single Access Point (AP) station 140, via a discrete wireless communications link 145. Each BSS 135 connects to the AP 140 via its BSS CCS 120 (not shown in FIG. 2; see FIG. 1). The AP 140 controls the routing of MAC Service Data Units (MSDUs) for all BSS 135 stations within its range that are associated with the AP 140. In the limiting case, e.g. smaller-scale networks and early prototypes, it is possible that a single BSS 135 may constitute an ESS 150 in its own right, in which case the BSS CCS 120 station takes on the function of an AP 140. There are security benefits to having discrete BSSs 135 arranged in one or more ESSs 150 in a wireless data network, as enhanced firewall protection and enhanced access to the network can be achieved by such arrangement. Using at least two ESSs, different carrier frequencies or different sufficiently separated channels may be used to avoid interference.

Typically the RF output from BSS CCS 120 to the AP 140 will be in the range of 1-4 W at 2.4 GHz, typically from a directional antenna (Yagi, parabolic or sectoral), although the RF output could be from an omnidirectional antenna. Each BSS CCS 120 performs the function of a repeater in that the MSDUs from individual stations are relayed to the AP 140.

FIG. 3 illustrates two ESSs 150 of the type shown in FIG. 2 that are interconnected via a suitable communications link, in this instance consisting of an AP backbone link 130, commonly referred to simply as a “backbone”. The AP backbone 130 is simply a peer-to-peer network connection between two network nodes of the same type: in FIG. 3 these nodes are AP stations 140. (The term “backbone” is also used to apply to the set of backbone links in more complex network architecture; there may be forks, stars and rings in the backbone of such more complex networks.) The backbone is implemented by means of transceivers and directional antennae. In FIG. 3, by way of example, only two AP stations 140 are shown as constituting the AP backbone 130, therefore only one directional antenna and transceiver would be required at each AP station 140 to implement the backbone. The backbone 130 facilitates the transfer of MSDUs from one AP station 140 to another AP station 140. Each AP station 140 is provided with suitable circuitry for controlling the routing of MSDUs between the AP stations 140, a backhaul station (BHS) 160 or other BSS CCS 135 stations.

The BHS 160 shown in FIG. 3 interconnects via communications link 155 to an AP station 140. This WM connection 155 is not a backbone since it is not a peer-to-peer connection. The BHS 160 station is higher in terms of network hierarchy than is the AP station 140, just as the AP station 140 is higher in terms of hierarchy than is any one of the stations 100, 105 or 115. Link 155 may be viewed as an uplink from the AP backbone 130 to a BHS 160 station or as a downlink from a BHS 160 station to an AP station 140. If the BHS 160 station illustrated were connected to another BHS station (not shown in FIG. 3), then a BHS backbone would exist between the two BHSs.

In FIG. 3, there is shown a small overlap (i.e., some territorial signal coverage overlap) between the two ESSs 150 illustrated, although the ESSs may be mutually independent as to signal coverage. The Figure shows that BSS CCSs may well overlap with a neighbouring ESS 150, but each BSS CCS 135 is affiliated with a specific ESS 150. Particularly in the case of mobile stations 105 (not shown in FIG. 3 but shown in FIG. 1), at some point along the path of travel of a given mobile station 105, the AP station 140 will hand over control of the mobile station 105 to a neighbouring ESS 150, or the BSS CCS 135 for that mobile station 105 will affiliate itself with the new ESS 150. The territorial signal overlap of the two ESSs 150 facilitates handoff and roaming. There exist interoperability standards, such as the Internet Engineering Task Force (IETF) Mobile IP standard, that may apply to handoff (handover) and roaming. The present invention is not directed to roaming techniques, path selection or substitution techniques, handover techniques as such, nor to routing techniques generally. Rather, the present invention is directed to providing suitable network infrastructures, and particularly to providing suitable topologies, that can support suitable roaming, path selection, path substitution, and routing techniques, and suitable software for implementing such techniques.

Co-located with the BHS 160 is a portal or gateway to the internet (not specifically illustrated in FIG. 3). The BHS 160 may transmit and receive at a selected frequency in the vicinity of 2.4 GHz, but more likely it will use a frequency of about 5.6 GHz at approximately 40-60 W using narrow-directional high-gain antennae (parabolic, or multi-element Yagi). Generally speaking, in order to avoid signal interference, it is best to use carrier frequencies for BHS transmission that differ appreciably from those used for AP transmission, with pass band filters if necessary. Because of the need for wireless AP backbone communications links 130 between APs 140, and for the wireless backhaul communications links 155 between APs 140 and the BHS 160 (i.e., the set of uplinks from APs 140 to BHS 160), there will be at least two transmitters at the AP 140—one transmitter providing the AP backbone 130 and the other the uplink 155 from AP 140 to BHS 160. Preferably these two transmitters will make use of carrier frequencies in two appreciably different frequency bands. Although not shown in FIG. 3, it is conceivable that some AP stations 140 will have no connection to a BHS 160; in such instances, the AP 140 would function only as a repeater, boosting the range of one AP station 140 via another AP station 140 that is in direct communication with a BHS 160. Antenna and transmitter configurations would vary depending on the functions performed by any given AP 140. APs 140 may also be used to facilitate management of network traffic (including flow rates, routing, authentication, security etc.). An AP station 140 may therefore be relatively more sophisticated in terms of functionality and equipment than a BSS CCS station 120.

In operation, the systems of FIGS. 1, 2 and 3 work as follows: A user of a station 100, 105 or 115 activates a conventional wireless computer device [not illustrated] to exploit a bundled service available through wireless internet connectivity. The wireless computer device sends a data packet signal or MSDU to its associated BSS CCS 120. The BSS CCS 120 may carry out various functions relating to access, security, sequencing, synchronization as per the IEEE 802.11 standards. Alternatively, in the interest of simplification, although this has not been disclosed in the prior literature and is considered to be novel, the BSS CCS 120 may simply pass on data packets in received sequence to an AP station 140, leaving to the processor of the AP station 140 the tasks of routing, access, security, sequencing, and synchronization, using the data in the packet header to control the processing of each individual data packet. Some of these tasks may be performed instead at the backhaul level by a BHS 160. Note that with suitable multi-port routers operating under the control of suitable routing software, several radio transmitters or receivers may operate through a single antenna. Further, the use of such multi-port routers operating under the control of suitable routing software at higher level stations may enable lower-level stations to operate without having to perform signal routing, security control, etc. Roaming becomes primarily a processor operation. The choices of software and methodology for effecting the foregoing functions and controls are not per se part of the present invention; rather, the present patent application discloses suitable network designs, topology, connections, and equipment selections that in combination provide a platform suitable for use with firmware, software and methodology effective to implement robust networks having desirable attributes of the sort described, including simplification of BSS CCS stations 120. In any case, a selected processor will identify the station 100, 105 or 115 and determine whether the station 100, 105 or 115 has permission to access the network further, or determine whether the station 100, 105 or 115 is already accessing the network through a neighboring and overlapping BSS 135.

Whether or not the BSS CCS 120 is involved in the packet routing control, it also searches for a connection to an AP station 140. Once such a connection is found and recognized as being authorized, the BSS CCS 120 may then send out MSDUs from associated BSSs 135 to the selected AP 140. The AP 140 functions as a central coordinating station for the BSSs 135, managing MSDU traffic. The AP 140 identifies the BSS 135 associated with the MSDU received and determines whether the MSDU is cleared for accessing the network further. The AP 140 identifies the destination of the MSDU and controls the routing of the message through the network, depending on the state of the network as determined by data available to the AP 140. Thus the MSDU may be directed on a known path to the BHS 160 via an internet gateway, to another AP station 140 via an AP backbone 130, or perhaps through an alternative route where network traffic and congestion are lighter. The AP backbone 130 facilitates hopping from one AP 140 to another AP 140 for routing efficiency.

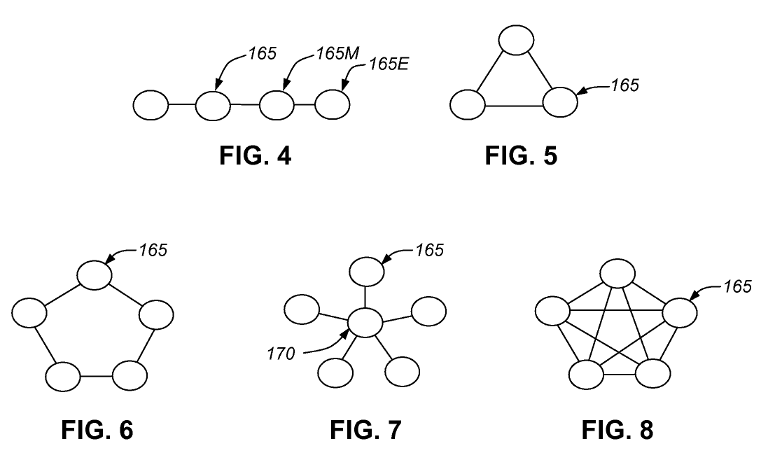

In each of FIGS. 4 to 10, representing various network or subnetwork topologies, an oval represents a network node 165, and a line interconnecting any two nodes 165 represents a transmission path (communications link) between those two nodes.

FIG. 4 shows a simple network comprising a linear array of network nodes 165. Network nodes 165 would typically be computer stations in a LAN, but when used to implement the present invention, may be stations 100, 105 or 115, or a BSS CCS 120, an AP 140 or a BHS 160, as the context may require. The failure of an end node 165E will not affect the remainder of the network of FIG. 4. The failure of an intermediate node 165M will result in the division of the network into two distinct network divisions of smaller size on either side of the break, one of which in the four-node example illustrated will be a stand-alone node. A failure in a transmission path will have a similar effect and will divide the network in two. The linear array is thus seen not to be robust in response to node failure.

FIG. 5 shows a simple triangular ring network. A failure of a transmission path converts the ring to a linear array of three nodes. A failure of any one of the nodes results in a linear array comprising the two remaining nodes. The triangular ring is therefore somewhat robust to node and path failure in that nodes in which no failure occurs remain interconnected.

FIG. 6 shows a pentagonal ring network. As in the case of the triangular ring network of FIG. 5, failure in any one node or path results in the ring network reverting to a linear array. Like the triangular ring, the pentagonal ring is robust to the extent that one node or path failure does not disrupt the interconnection of the operative nodes, which latter constitute a linear array as long as the failed node remains inoperative.

FIG. 7 shows a star network, sometimes referred to as a star array. A failure in any one satellite node (i.e., any node other than the central node 170) or path will result in the dropping out of only that one of the nodes from the network. But if the central node 170 fails, the entire network will fail. A star network is relatively easy to control and coordinate; therefore logic circuitry is minimal. An omnidirectional antenna at the central node 170 and directional antennae at the satellite nodes are sufficient for implementation of communication between the nodes. The network is however vulnerable in that it relies heavily on the continuing functioning of the central node 170; a failure in central node 170 causes the entire network to fail. The star network is not robust.

FIG. 8 illustrates a pentagonal mesh. At any node, there are a number of paths from that node to any other. If any one interconnection between one node and an adjacent node fails, or if a node fails, other paths remain operational. Such an arrangement, as the number of nodes increases, becomes increasingly difficult to configure, to control and to implement, as it requires a relatively large number of antennae and complex logic circuitry for its implementation. It is however relatively reliable and robust.

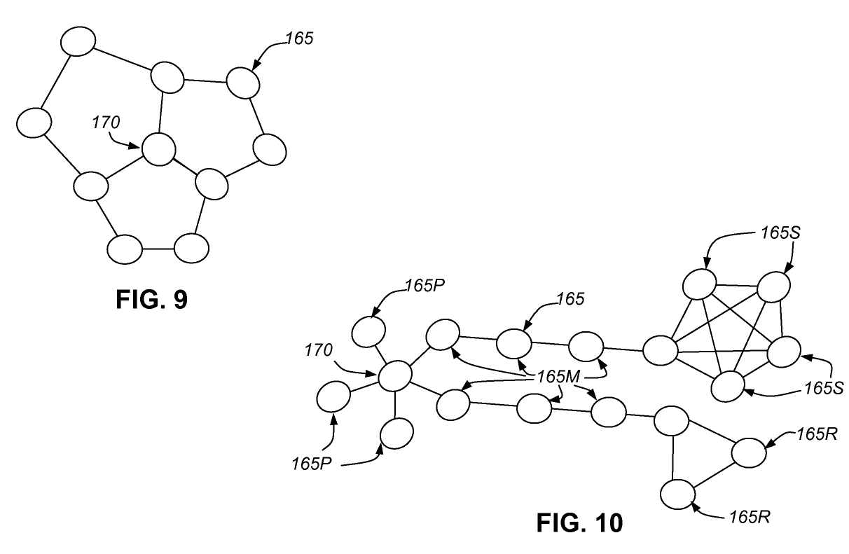

FIG. 9 shows a hybrid interconnection of three rings, in what is called a cluster. The cluster is a composite of the network topologies of FIGS. 4 through 7. The failure of the cluster center node 170 will result in the cluster reverting to a ring; compare FIGS. 5 and 6. Failure of both ports of any other node 165 having only two ports results in conversion of the cluster to one having two rings and a connected linear array having one node that is also connected to a ring and one node outside a ring. Failure in any other node having three ports (but not the center node 170) results in conversion of the cluster to one having one ring and two linear arrays outside but connected to the ring, each linear array having two nodes plus a third node also connected to the ring. FIG. 9 is an embodiment of the MITRE™ Wi-Mesh system. In that system, each node stores monitoring information about path distances from any one node to a destination node; thus if one node fails and the network structure changes, the node may direct MSDUs to their intended destination node by the known shortest available route.

FIG. 10 shows a hybrid of a star network, two linear arrays, a pentagonal mesh and a triangular mesh. This network is complicated; it is exemplary of what can result from the evolution of an ad hoc network design. The term “ad hoc” implies that there has been no predetermined final design of the overall network topology, and usually implies that there is no network hierarchy. The impact of the failure of certain nodes on the network may have serious effects. Were central node 170 to fail, three peripheral nodes 165P would become isolated from the remainder of the network, which remainder would constitute two disconnected smaller networks each comprising a linear array and its appended mesh. Were any of the peripheral nodes 165R of the triangular mesh or 165S of the pentagonal mesh to fail, the remainder of the network would be unaffected. Were one of the intermediate nodes 165M in either linear array to fail, the network would be divided in two. The robustness of a hybrid network is therefore determined to some extent by the relative strengths and weaknesses of the underlying simpler network topologies of which it is a composite.

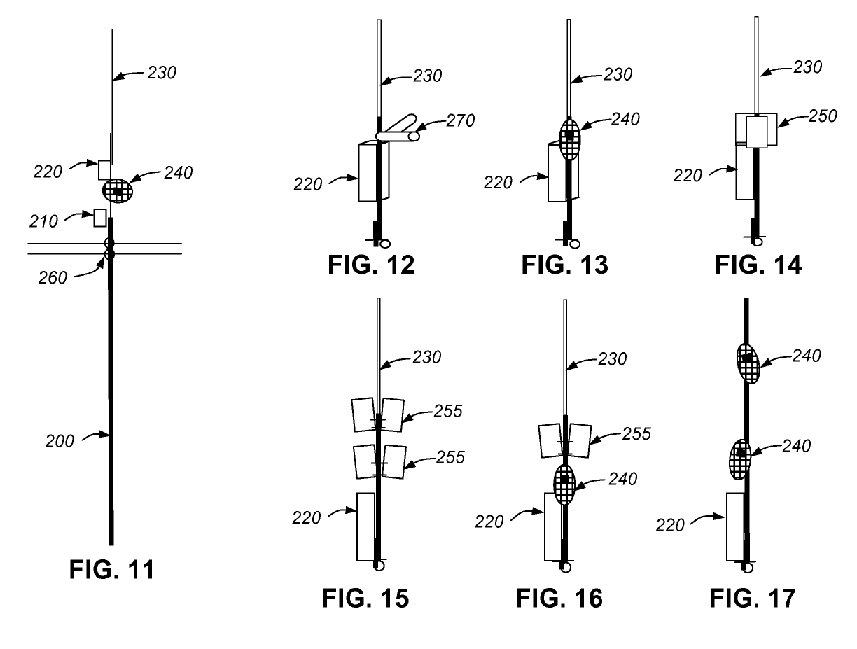

FIG. 11 illustrates equipment for a basic network station as it might be mounted on a utility pole 200. The utility pole 200 could be a street lamp pole or the top of a building or some other prominent and adequately high object. In FIG. 11, the mount is shown by way of example as located on an electric utility pole 200 that also supports electric power lines 260. An upper antenna 230 is fixed to a mount in turn fixed to the pole 200. A lower antenna 240 is mounted underneath the upper antenna 230. The upper antenna 230 is illustrated as an omnidirectional antenna, and the antenna 240 as a directional antenna, stylized in the schematic illustration of FIG. 11 as a parabolic antenna.

The network station of FIG. 11 includes a weatherproof, ultra-violet-ray resistant control box 220 conveniently interposed between the two antennae 230, 240. Additional shielding may be provided for the control box and between the two antennae 230, 240 as required. The control box 220 may contain a combination of conventional network station devices and apparatus. The selection is made having regard to the functions to be performed by the station. Various items of network equipment such as filters, power connections, amplifiers, transceivers, transverters, network routing and controlling equipment, processors and switching logic may be installed in the control box 220. (As mentioned above, some of the foregoing equipment could be omitted from the control box 220 for a BSS CCS 120 if various of the routing and control functions are performed instead at a linked AP station 140 or at a backhaul station 160.) Associated software would be provided as required. In FIG. 11, a power supply 210 is shown mounted slightly below the antennae 230 and 240, preferably in a separate weatherproof, ultra-violet (UV) ray resistant control box; alternatively, the power supply 210 may be provided within the control box 220. The control box 220 may be coupled to a power-over-the-Ethernet (“PoE”) cable (not shown), connected to the radio circuitry inside the control box 220 at one end and to a terminal (e.g., cable connector) accessible to an on-site system administrator at the other end. In this manner, the system administrator may program and configure the firmware of the network station. On an electric utility pole, for example, the PoE cable might terminate approximately fifteen feet from the base of the pole, in order to discourage vandalism or tampering at street level. Access to the PoE port may be controlled, e.g. by means of a padlocked enclosure or perhaps password protection or authentication in the network station firmware, or a suitable combination of security arrangements. All data and power cabling should be shielded to prevent radio-frequency (RF) interference. Standard antenna connectors may be used (including for example “N”-type, SubMiniature version A (SMA) etc.). Spacing of all hardware devices should be selected to minimize interference and to avoid harmonics.

The location of the control box 220 on the utility pole 200 should be chosen to be in close proximity to the station's antennae 230 and 240. The location should also be chosen to avoid or minimize local radio frequency interference to the extent reasonably possible. The reason for the close proximity of control box 220 to the antennae 230 and 240 is to keep the requisite RF signal feed cables as short as possible in order to limit cable losses, which can sometimes cause significant attenuation, especially in long cables at higher frequencies of operation. Shorter cables also help to avoid reception of and transmission of RF interference.

FIGS. 12 through 17 illustrate antenna configuration variants for use in the selective implementation of various wireless network nodes. These antenna configurations may be used with the BSS CSS 120, the AP 140 or the BHS 160 shown in FIGS. 1, 2 and 3. In each case, at least two antennae are mounted on a suitable pole or other structure, the details of the support structure and mount being omitted for simplicity. In all of these diagrams, the control box 220 is located immediately beneath all antennae, but alternative sequencing of these elements may be preferred, as illustrated for example in FIG. 11. Where two separately functioning antennae are mounted on a common pole or other structure, suitable shields may be interposed between the antennae to prevent or limit mutual interference. Except in the case of FIG. 17, all antenna variants illustrated include an uppermost omnidirectional antenna.

FIG. 12 shows beneath the uppermost omnidirectional antenna 230 two high-gain, directional, Yagi antennae 270, consisting of many directional elements (not individually shown). The antennae 270, or all of the antennae illustrated, may be covered by a radome.

FIG. 13 shows an antenna configuration including an upper omnidirectional antenna 230 and a lower high-gain parabolic antenna 240. The gain of a parabolic antenna is typically much higher than that of a Yagi antenna 270 of the type illustrated in FIG. 12. The parabolic antenna 240, like the Yagi antenna 270 in FIG. 12, is directional and therefore not suitable for roaming. It is possible that both directional antennae could be mounted on a tracking rotor, but that is not normally desirable since it would add considerably to the loading of the antenna mast and may require the installation of a larger, more robust mast.

FIG. 14 illustrates an antenna configuration having an upper omnidirectional antenna 230, below which are mounted three 120° sector antennae 250. The sector antennae 250 are not shown down-tilted; however, down-tilting may be desirable in order to limit range of coverage.

FIG. 15 shows an upper omnidirectional antenna 230 and below it two 180° pairs of sectoral antennae 255, shown downtilted. This configuration could be suitably used for the implementation of an AP station 140. MSDU traffic to and from the BSS CSS 120 stations to the AP station 140 could propagate via the omnidirectional antenna 230. One 180° sector antenna pair 255 could be used to establish the backbone connection between the AP stations 140 and the link to one or more BHS 160 stations; while the other sector antenna pair 255 could be used to establish the backbone connection between the AP station 140 of FIG. 15 and neighboring AP stations 140. In some instances it might be preferable to make use of a parabolic antenna 240 rather than sector antennae 250 or 255, depending on distance, propagation, obstacles and so forth. As mentioned, the frequency choices for the different communications channels should be selected to be sufficiently different that interference is minimized. For example, the backhaul uplink carrier frequency could be chosen to be in about the 900 MHz range, that for the downlink from the AP stations to outdoor customers in the 2 GHz range, and that for the downlink from the AP stations to indoor customers in the 5 GHz range.

FIG. 16 shows an antenna configuration that would be suitable for at least some types of BHS 160 . Signals to and from AP station 140s could travel via the omnidirectional antenna 230. A BHS backbone, not unlike the AP backbone 130, could be established via the sector antennae 255. The parabolic antenna 240 could be used to establish the communications link between the BHS 160 station and some other station which might have overall control of the entire network—e.g., a central controlling office 190 (to be discussed below with reference to FIG. 24).

FIG. 17 shows another possible antenna configuration. Here, no omnidirectional antenna 230 is present. Instead, two parabolic antennae 240 are illustrated, one mounted above the other. This configuration is an example of a configuration suitable for a directional relay or repeater station. Typically transceivers attached to the two parabolic antennae 240 would operate at different frequencies as repeaters, or in different bands as a transverter (or cross-band repeater). Such arrangements are typically used in order to achieve long-distance network links, for example in the Mikrotik™ Nstreme and Nstreme2 wireless protocols; they are per se representative of prior art. One antenna could be dedicated to transmitting and the other to receiving. The antenna arrangement in FIG. 17 is configured as suitable for use as a relay, but it could be used in combination with an antenna configuration such as that shown in FIG. 12, to form an AP station 140 with relay capability to a BHS 160 (this combination is not illustrated). The link between the AP 140 and the BHS 160 could be achieved using the directional relay as an intermediate station between the AP 140 and BHS 160. This option would reduce loading on the antenna mast and might be used to circumvent obstacles or achieve longer transmission paths.

While FIGS. 12 through 17 illustrate some of the possible antenna configurations possible, the choice of what configurations to use is a decision to be made by the designer and installer of the network, taking into account the environment in which the network is to be installed and the topology desired.

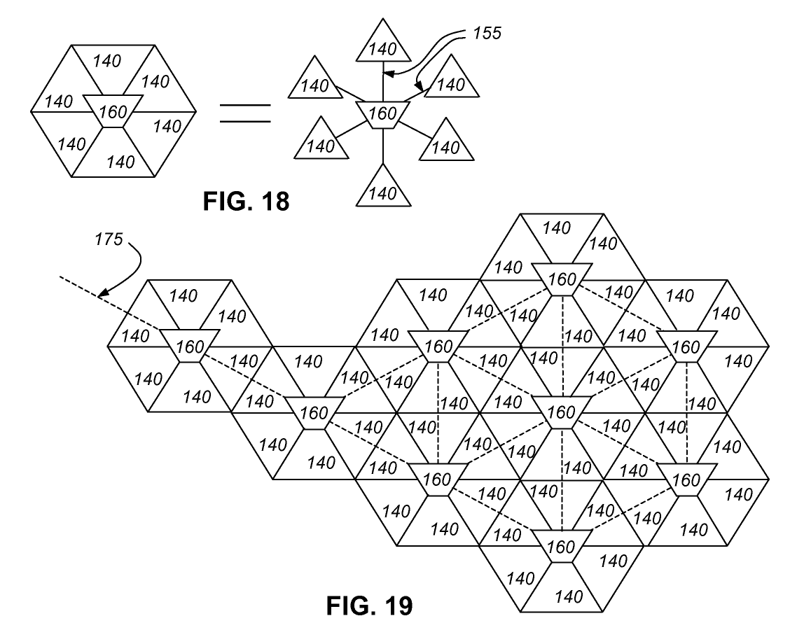

FIG. 18 is an illustration of the Motorola CANOPY® network architecture. Each AP station 140 communicates with a BHS 160 in what is sometimes referred to as an “AP cluster” of no more than six AP stations 140. This “cluster” is not a true cluster of the sort illustrated in FIG. 9, but rather is a hexagonal star array (star network), comparable to that illustrated in FIG. 7. Each CANOPY® “AP cluster” can therefore be represented in a hexagonal diagram, as in the left view of FIG. 18, or in a conventional star-array presentation, as in the right view. The CANOPY® AP star array has six nodes (AP stations 140) around a central node (BHS 160). There is no communication between any two AP stations 140 within the array and therefore there is no internal backbone; therefore there is no mesh or ring in this basic topology, just a basic star topology. There is an uplink connection (backhaul communications link 155) from each AP station 140 to the BHS 160. The design approach is analogous to a mobile communication network in which the outer nodes of the star array are mobile communication network users and the central node is a base station connected to the PSTN.

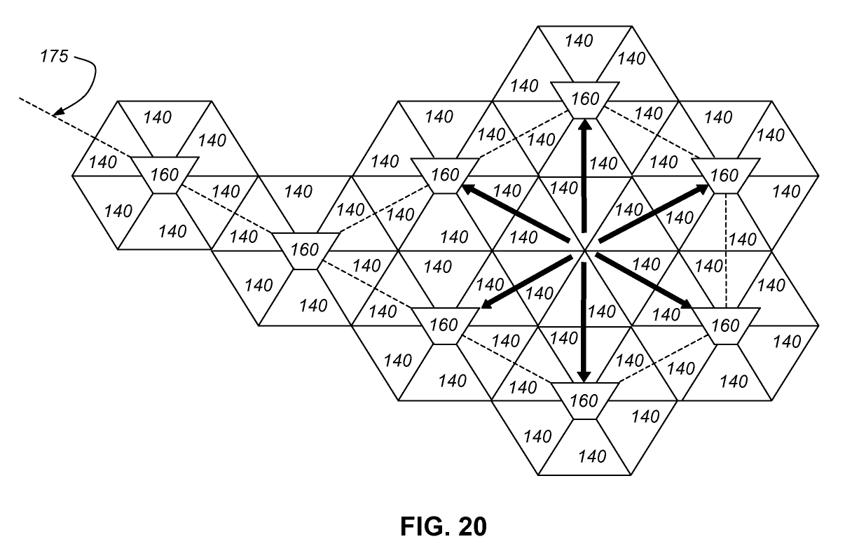

FIG. 19 illustrates an example of the resulting network topology of interconnected FIG. 18 arrays. In the diagram, the star arrays for convenience are illustrated as contiguous hexagons, but this is not intended to imply physical or geographic contact. (There is communications contact between adjacent star arrays, as will be described below.) As in FIG. 18, in each hexagonal star array there are six satellite APs 140 and a single central BHSs 160. Neighbouring BHSs 160 are linked together by backbone links 175, illustrated as broken lines. (The backbones are shown in broken lines in this diagram and also in FIGS. 20-22, but not otherwise.) The resulting backbone architecture includes a triangular ring mesh consisting of triangular rings in the backbones 175 linking the BHSs 160. The triangular ring mesh is an array of triangular rings of the type shown in FIG. 5, the nodes 165 of FIG. 5 being the BHSs 160 of FIG. 19. In the FIG. 19 network, there is normally no communication between AP stations 140 within each hexagonal star array nor from any given AP station 140 to any neighboring AP stations 140 in a different hexagonal star array. To any given CANOPY® array there could be added a peripheral AP station 140. It may be preferred, at least for transitional purposes, not to establish immediately a new BHS station to serve the added AP station 140. In such cases, the added AP station 140 could be linked by an AP backbone link to a neighbouring AP station 140 as a relay to the nearest BHS 160 station. To that extent, there would be formed a limited AP backbone.

FIG. 20 illustrates the consequences of one type of possible failure of the Motorola CANOPY® design. If any one BHS 160 fails (represented in the diagram by a missing BHS 160; compare FIG. 19), the BHS backbone 175 is still sufficiently robust to be unaffected. The AP stations 140 served by the failed BHS 160, however, are affected. The six AP stations 140 in the affected AP hexagonal star must either: 1) find another BHS 160 to which to communicate MSDUs; or 2) relay their MSDUs through neighboring AP stations 140. In order to find an alternate BHS 160, each of the six isolated AP stations 140 would need to search (or roam) to find an accessible BHS 160, or to link to an accessible AP station 140 having a link to a BHS 160 and establish a relay through it to such BHS 160. MSDUs would then be sent from the affected AP station 140 via an adjacent AP station 140 to an operational BHS 160—a minimum of one hop through one neighboring AP station 140 (as indicated by the arrows in FIG. 20). Network management software at each of the six affected AP stations 140 is preferably designed to be able to identify which BHS 160 has failed and to attempt to establish a communications link with the nearest or some other AP station 140. This improvised communication requires at least one extra hop in the network from each affected AP station 140 to the nearest available BHS 160. Antennae and transceivers would need to be configured for this contingency or would have to be dynamically adjusted through the use of software.

It is thus seen that a problem with the Motorola CANOPY® array is that as BHSs 160 fall out of network service, the wireless network connections between AP stations 140 in the affected hexagonal stars rely more and more on hopping across the AP stations 140 of neighboring hexagonal stars. Those AP stations 140 within the affected hexagonal star networks may start to revert to one or more linear arrays of nodes communicating with neighboring nodes of adjacent star networks in the overall mesh. MSDUs, being passed from affected AP stations 140 through adjacent AP 140 stations in neighboring star networks, are perforce queued. Assuming that MSDU traffic is distributed roughly evenly in the case of one BHS 160 failure, then in total, twelve AP stations 140 are affected and six BHSs 160 are affected by a single BHS 160 failure, as illustrated by the bold lines representing improvised links in FIG. 20 following failure of the BHS 160 at the centre of this bold-line configuration.

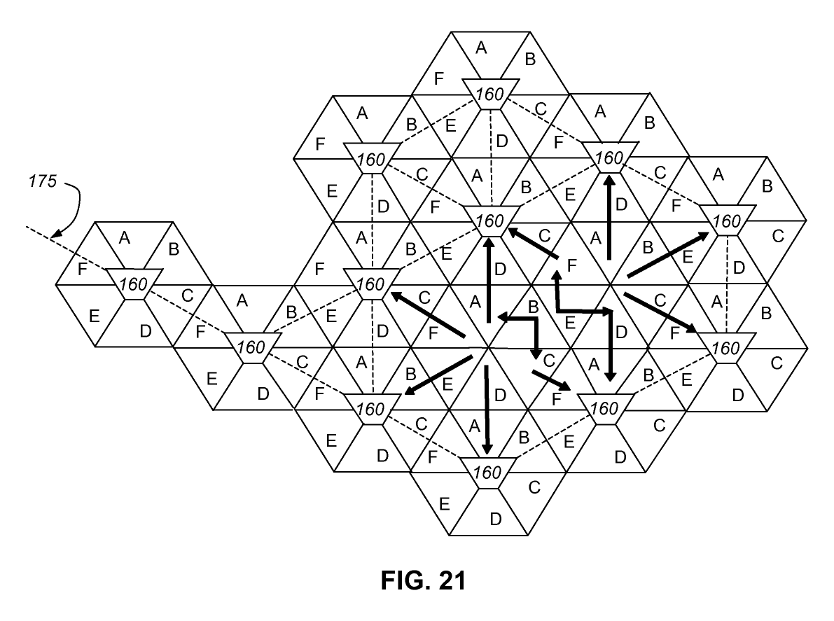

FIG. 21 illustrates what happens when two adjacent BHS 160 stations in a Motorola CANOPY® array fail. In the diagram, AP stations 140 have been labelled by the letters “A” to “D” in order to distinguish individual AP stations 140 within each star, from one another. In the case of two neighbouring AP stations 140 in the affected BHS 160 areas, a minimum of two hops can be expected across adjacent AP stations 140 to the nearest BHS 160 station (as indicated by the arrows), although the majority of AP 140 hops go through only one neighboring AP station 140. FIG. 21 illustrates AP hopping within an AP star as shown by the arrows in the lower affected star (paths B-A-D and B-C-F) and in the upper affected star (paths E-F-C and E-D-A). AP hopping in the event of two BHS 160 failures involves more AP stations 140 than in the case of a single BHS 160 failure.

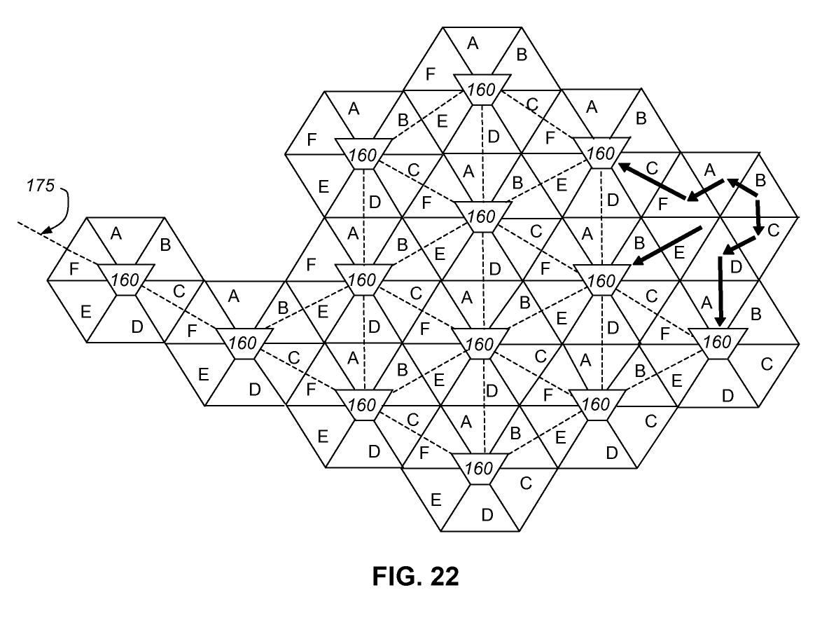

While a failure of adjacent BHSs 160 in the CANOPY® design is serious, FIG. 22 shows that the failure of only one BHS 160 on the periphery of CANOPY® mesh is perhaps even more serious. MSDUs from the most peripheral AP station 140s (labeled in sequence A, B and C in the area of the arrows), in the affected hexagonal star in which the BHS 160 has failed, must hop from one to three AP stations 140 to reach a BHS 160 in a neighboring hexagonal star (as indicated by the arrows). Yet that hopping situation is even worse because AP 140 traffic from other AP stations 140 in the failed hexagonal star is also being queued for hopping. The symmetrical distribution of network traffic shown in FIG. 19 does not exist in the case of a failure of a peripheral BHS 160 in the CANOPY® mesh design.

In the network of FIG. 24, AP stations 140 are linked to one another via the AP backbone 130. BHSs 160 are linked via the BHS backbone 175. Each AP station 140 is linked to two different BHSs 160 via links 155 thereby forming a mesh of unique triangular networks. Each BHS 160 is linked to two different AP stations 140 thereby forming a mesh of unique triangular networks.

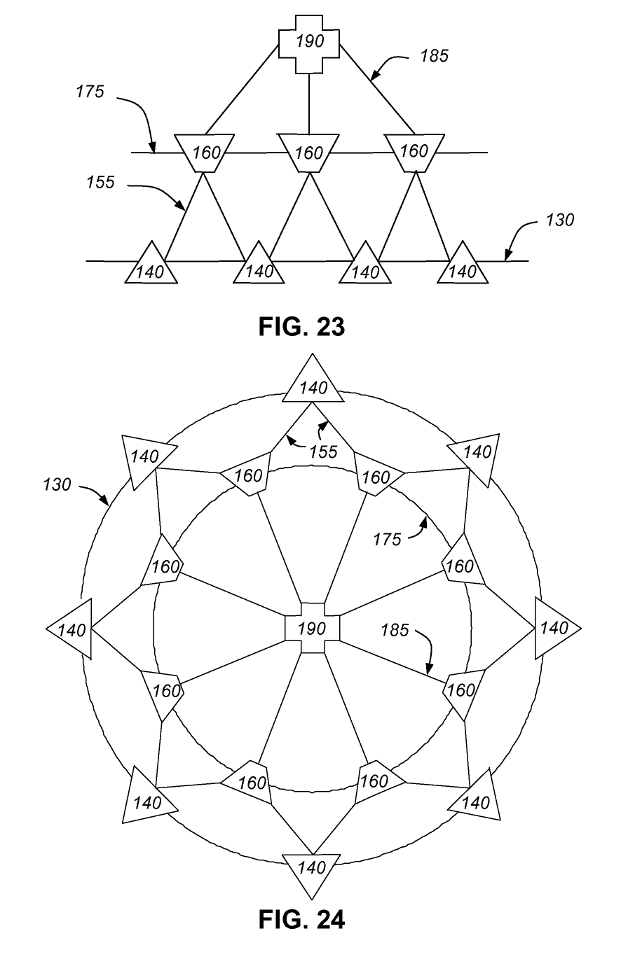

While FIG. 24 is a schematic diagram of the flower topology in a preferred embodiment of the invention, it is also useful to consider FIG. 23, being a portion of the FIG. 24 embodiment, which simplifies the distinctions between the inventive topology and the Motorola CANOPY® topology, and shows how the inventive network overcomes failure-caused hopping and traffic rerouting problems associated with a CANOPY® AP star network. In contrast to the CANOPY® network structure that is essentially a mesh of star networks, the preferred embodiment of the invention herein described with reference to FIGS. 23 and 24 utilizes a novel network topology. Neighbouring AP stations 140 are connected together via an AP wireless backbone 130 in what, in FIG. 23, is a linear array similar to that of FIG. 4. Each AP station 140 is linked to two and only two neighbouring AP stations in the array. In the event of a failure, hopping along the backbone 130 is limited to only the two neighboring AP stations 140 from any one AP station 140.

Each AP station 140 (except perhaps the two end AP stations if only FIG. 23 is considered, although if the entire network is configured as shown in FIG. 24, this exception does not exist) has a backhaul communications link 155 to each of two different BHS 160 stations. This limited AP-to-BHS linking avoids the need for any AP station 140 to behave like a central node in a star network in the event of a node failure. The BHSs 160 are at a higher hierarchy in the network than is the AP station 140, therefore transmissions from an AP station 140 to a BHS 160 are uplinks, whilst transmissions from a BHS 160 to an AP station 140 are downlinks. The BHSs 160 are interconnected by BHS backbone(s) 175 established to allow peer-to-peer communications between the BHSs 160. The BHSs 160 are, as presented in FIG. 23, interconnected in a linear array similar to that of FIG. 4. The backhaul communications links 155 interlink the AP backbone 130 and BHS backbone 175 to form a mesh of triangular rings, each based on the triangular ring concept of FIG. 5. Note that each triangular ring in the mesh is unique.

Of course, the number (8) of AP stations and BHSs illustrated in FIG. 24 is exemplary only; any desired number could be present, provided that a triangular mesh of the type described above exists. However, the advantages of the present invention tend to be realized optimally when that number is no lower than 3 and not so high as to introduce an undesirably high level of complexity in the control functions of the central control station 190. If the number of BHSs is perceived as being too high, then more than one control station 190 may be provided for the network so as to reduce the ratio of BHSs to control stations; possible embodiments of such variant are discussed further below. Note further that the ratio of AP stations to BHSs may be greater than 1; see for example FIG. 30.

With the underlying structure described above, the inventive network of FIG. 24 avoids the use of an unreinforced star network and the vulnerability of its central node. Should any BHS 160 fail, MSDUs may be re-routed through an alternate BHS 160, without a need for hopping through another AP station 140. Hopping through another AP station 140 remains an available option, but in the event of a single failure, a path to a neighbouring BHS 160 is always available. If two adjacent BHSs 160 fail, then there is still a path to another BHS 160 via a single AP station 140 hop. Unlike the prior CANOPY® array, a triangular ring mesh is exploited in the preferred embodiment of the present invention illustrated in FIG. 24, with its inherent superior robustness to nodal failure as compared to a star network.

As illustrated in FIG. 24, all BHS 160 stations are linked to a central controlling office 190. The controlling office 190 maintains control over the entire network of FIG. 24, including control over the flow of traffic, security, detours, monitoring, etc. Some network management and control functions may be distributed or delegated to BHSs 160, AP stations 140 and BSS CCS stations 120, but the ultimate overall network command and control is vested in the controlling office 190. The BHSs 160 and the controlling office 190 are linked by communications links 185. Since communications links 185 conform to the hierarchical network structure, transmissions from BHSs 160 to the controlling office 190 are uplinks and transmissions from the controlling office 190 to the BHSs 160 are downlinks. The basic network topology of the controlling office 190 and the linked BHSs 160 is a star network with the central node being the controlling office 190, much as in FIG. 7, but with interconnection of all BHSs 160 via backbone 175. The vulnerability of the central node can be overcome by keeping the overall network operation at least to some degree independent of the controlling office 190 so that failure of the controlling office 190 does not cause complete network failure. This objective can be accomplished at least in part by having one or more alternate controlling offices 190 (not specifically shown in FIG. 24) supplement the network of FIG. 24, or be substituted for or co-located with selected BHSs 160. Further, because any BHS station 160 can connect to the controlling office 190 via backbone 175 and an adjacent BHS station, the network is robust as long as the controlling office 190, or a supplementary or substitute or co-located controlling office, remains operational.

FIG. 24 is thus seen to be a preferred embodiment of the inventive network, making use of and including the simpler structure shown in FIG. 23. (The mesh design of the FIG. 24 network with its circular symmetry (as a conceptual diagram, not as a physical reality) somewhat schematically resembles a flower, so the network may conveniently be referred to as a “flower network”, and may be whimsically viewed as comprising a smaller annular array of shorter “petals” 160 and a larger peripheral annular array of longer “petals” 140. (The term “flower network” is used in the network art to describe various networks that when conceptualized and illustrated schematically may have generally circular symmetry and tend to resemble a flower.) While additional redundancy beyond that illustrated in FIG. 24 could be provided, it would add levels of complexity to routing and control that would not be expected to improve appreciably the robustness of the network. For most purposes, redundancy of signal paths need only be made available between any two nodes in a given network that are intended to be directly linked, and that redundancy may be limited to the provision of only one alternate link.

Note that the robust character of the network depends upon the presence of the foregoing triangular meshes that provide link redundancy. However, a network having some but not all of its BHSs linked to two different AP stations to form a triangular ring, or some but not all of its AP stations linked to two different BHSs to form a triangular ring, would still be robust to the extent that selected ones of the AP stations and BHSs are linked in the manner shown in FIG. 24. A network designer seeking to contrive a relatively robust network while attempting to avoid this patent conceivably may elect to reduce the total number of links in the network from the number required to give complete link redundancy, so as to avoid redundancy for some links. Note that if a given link 155 were for the foregoing reason omitted from a low-traffic area of the network, then if the remaining link 155 from the AP station 140 in question failed, that AP station 140 could maintain connectivity to the network only by hopping through a neighbouring AP station 140. To the foregoing extent, such part of the network would not obtain the benefit of the link redundancy provided by the flower topology of the present invention. But if the traffic through this part of the network were relatively low, the lack of link redundancy in the low-traffic part of the network could conceivably be tolerable. However, since the establishment and maintenance of a wireless communications link 155 are not expensive, one would expect the network designer to take full advantage of the benefits of the invention throughout the network, and therefore to provide link redundancy throughout, unless the designer were seeking a stratagem to avoid patent infringement. Note that the residual network excluding any portion not completely protected by redundancy would continue to satisfy the criteria of the present invention; such residual network is considered to be within the teachings of the invention, and is not outside the teachings of the invention merely because the larger network does not implement the redundancy principle throughout.

In FIG. 24, each of the BHSs 160 is linked to the controlling office 190 by means of a controlling office-to-backhaul link 185. Links between the controlling office 190 and the BHSs 160 are effectively those of a star network. The effects of a failure of the controlling office 190 (and star network) can be mitigated through the use of delegation of controlling functions to an alternate controlling office 190, which alternate office may be co-located with a connected BHS 160 station. The BHS backbone 175 is that of a ring network. The AP backbone 130 is that of a ring network. The BHS backbone 175, AP backbone 130, and backhaul communication links 155 are effectively those of a triangular ring mesh; and when coupled with the controlling office backhaul link 185, connected to the controlling office 190 and interconnected in a closed loop, together they form the preferred flower mesh topology of FIG. 24.

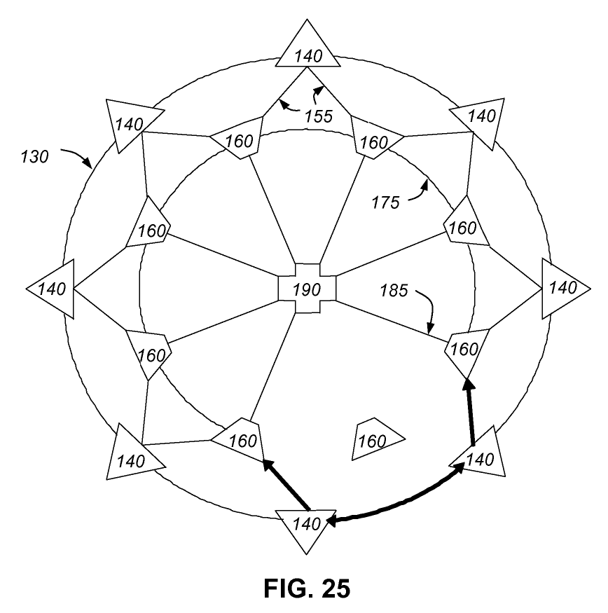

FIG. 25 illustrates the effect of one BHS 160 dropping out of service in the flower network. The AP stations 140 simply resort to their secondary BHS 160 connection, as shown by the bold arrows (an uplink from AP station 140 to a BHS 160 is shown, but the MSDU traffic is two-way even though not specifically illustrated). The dropping out of the BHS 160 will be observed by the controlling office 190 as it monitors the network traffic and state of the stations, but network traffic will remain largely unaffected because no AP 140 hopping is necessary (although it is possible, involving the bold two-way arrow beneath the failed BHS 160. There is no need for additional hopping across other AP stations 140 because each AP station 140 remains in communication with at least one BHS 160. This robust flower network accordingly represents a significant improvement over the CANOPY® mesh; compare the analogous CANOPY® situation illustrated in FIG. 20. The improvement in the flower network of the invention is due largely to the fact that any given BHS 160 is not dependent on a star structure for communications with AP stations 140, but rather relies upon a triangular ring mesh.

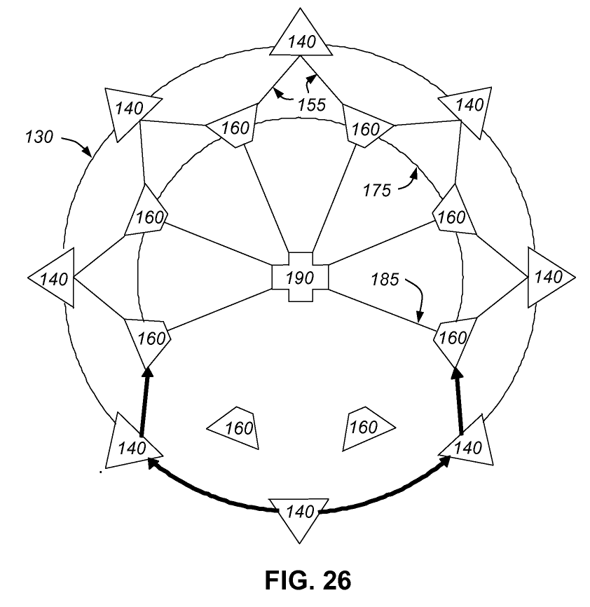

FIG. 26 illustrates the effect of two neighboring BHSs 160 dropping out of service. The two failed BHSs 160 are shown disconnected form the network. Their failure leaves a completely isolated AP station 140 and two partially isolated AP stations 140, as illustrated. The two partially isolated AP stations 140 continue to operate normally, as each can access a neighboring BHS 160, as shown by the bold arrows (an uplink from AP 140 station to BHS 160 , but the MSDU traffic is two-way even though not specifically so illustrated). The isolated AP station 140, located between the two partially isolated AP stations 140, need hop through only one of the two adjacent partially isolated AP stations 140 in order to communicate with a BHS 160. Traffic congestion at the neighboring AP 140 node could be halved by distributing traffic from the affected AP station 140 in approximately equal quantities to its two neighboring AP stations 140. Alternatively (and not shown), the isolated AP station 140 could attempt to seek a communications link with any other BHS 160 or even with the controlling office 190 directly. In practice, neither of the two preceding alternatives is likely, because typically power limitations within the isolated AP station 140 will not suffice for more remote connections; the nearest BHS 160 and the controlling office 190 are both likely to be outside of the range of the isolated AP station 140. But the two one-hop alternative connections available to the isolated AP station 140 should suffice to maintain near-normal performance of the network. Roaming is not necessary to keep the network functioning. No problem of asymmetric queuing of MSDUs need arise. One may contrast the failure of two adjacent BHSs 160 in FIG. 26 with the same event in the CANOPY® network illustrated in FIG. 21. Furthermore, in the flower network of FIG. 26, the problem of the failure of a peripheral BHS 160 is not as serious as would be the case in the CANOPY® design illustrated in FIG. 22.

The selective use of Yagi antennae 270, sector antennae 250, parabolic antennae 240 and omnidirectional antennae 230 as shown in FIGS. 12 through 17 should suffice to devise an AP antenna configuration enabling any AP station 140 to rely on the AP backbone 130 in the event of multiple BHS 160 failures.

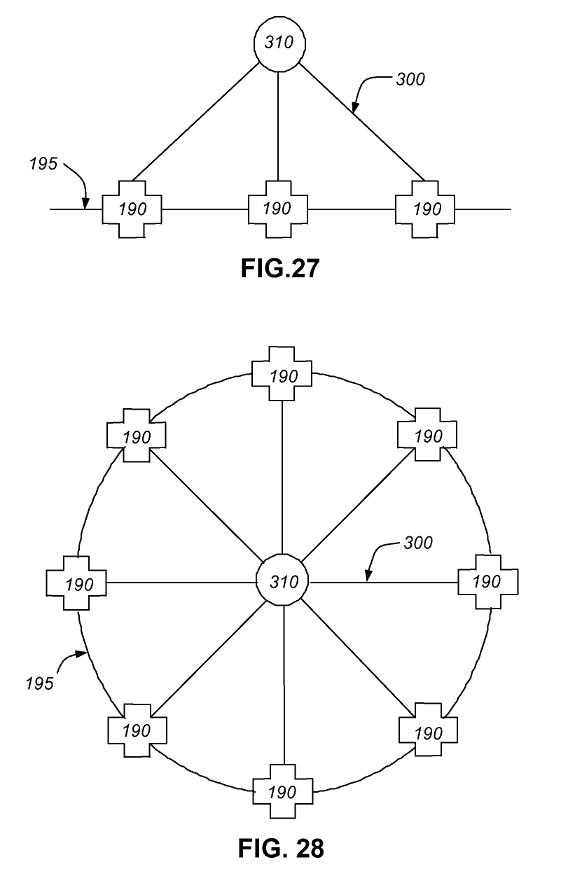

FIG. 27 shows how multiple networks of flower meshes can be linked together via a multiple controlling offices 190 in a fashion that mimics the flower mesh topological structure shown in FIG. 23. In FIG. 27, the controlling offices 190 are at the center of a flower network topology of the sort illustrated in FIG. 24. The remainder of the nodes and their links are not shown. The controlling offices 190 are interconnected by a controlling office backbone 195. Overall command and control of the entire amalgamated network is vested in a super controlling office 310 connected to all controlling offices 190 by means of a super backhaul link 300.

FIG. 28 illustrates the scaled-up network mimicking the inventive flower network topology and including the FIG. 27 mesh as part of the overall network structure. Any failure in a controlling office 190 will not disable the overall network. Furthermore, the isolation of the subnetwork dependent on controlling office 190 may be mitigated by ensuring that at least one of the subordinate BHS 160 stations in each dependent network is capable of communicating with the super controlling office 310 directly, and capable of acting as a substitute controlling office 190. Alternatively, at least one of the subordinate BHS 160 stations should be capable of communicating with a neighbouring controlling office 190. As a further alternative, at least one of the subordinate BHS 160 stations could be capable of communicating with a neighboring BHS 160 in the network of an independent controlling office 190, thereby attaching the affected subnetwork as a satellite to an unaffected one. Following the extrapolation methodology of FIGS. 27 and 28, the flower network could be scaled upwards to cover a large geographical area.

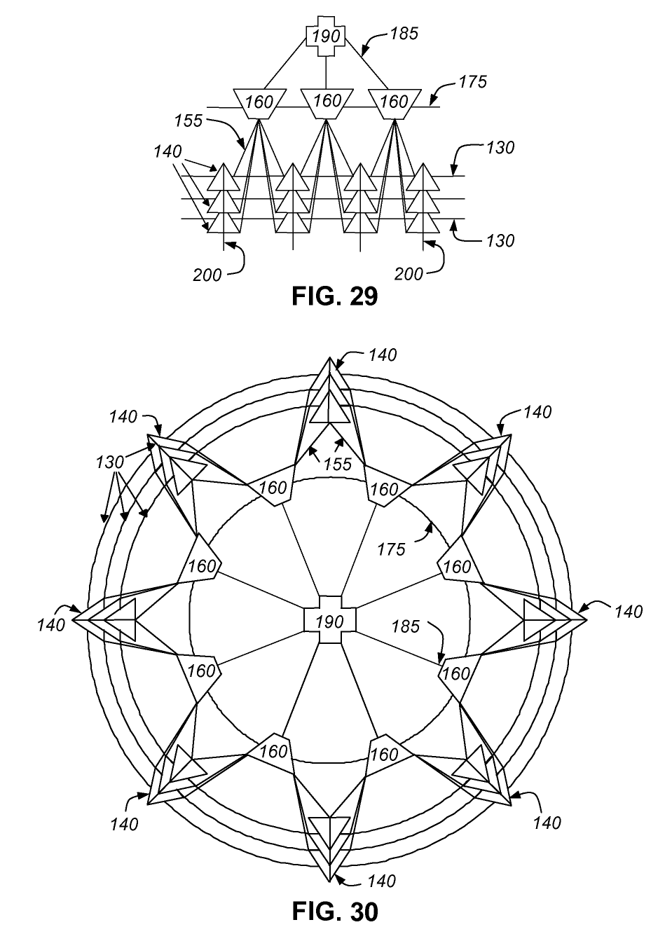

FIG. 29 is a variant of part of the inventive flower topology shown in FIG. 23. Instead of having only one AP station 140 interconnected to other AP stations 140 via a backbone 130 and via a backhaul link 155 to two BHSs 160, families of multiple AP stations 140 may have backhaul links 155 to the same two BHSs 160. The number of AP stations 140 linked to any BHS 160, i.e., the number of AP stations 140 in any family, is determined by the capacity of the BHS 160 to handle multiple AP 140 backhaul links and their associated MSDU traffic. It is of course not essential that the same number of AP stations 140 be provided in each family. Furthermore, sets of concentric AP backbones 130 may be configured (shown as horizontal AP backbones 130 in FIG. 29) so that each backbone 130 serves one AP station 140 in each family. Yet another set of AP backbones 200 (shown as vertical backbones in FIG. 29) may be provided, one for each family of AP stations 140. Although the backbones 200 would involve the use of additional antennae and transceivers, their presence would result in a rectangular grid mesh instead of just a linear network AP backbone. The advantage of an AP rectangular grid mesh such as that shown in FIG. 29 over the linear AP backbone 130 shown in FIG. 23, is that if an AP station 140 fails, the disruption to the AP backbones 130, 200 is minimal. An AP rectangular grid mesh need not be the only type of AP mesh and others are possible. In all cases, however, all AP stations 140 are configured with two backhaul links 155 to two different BHS 160 stations in order to exploit the robustness of the network to BHS 160 failure.

FIG. 30 is a variant of the full inventive flower topology shown in FIG. 24, making use of the underlying structure shown in FIG. 29. Again an 8-fold symmetry is present in the topology, but the number 8 of BHSs and AP stations is arbitrary and exemplary. Further, the number of AP stations in a family may vary from family to family; the number 3 in the illustration is exemplary only. A failure in a BHS 160 will have little effect on the network as a whole, as all AP stations 140 still have at least one backhaul link to an operational BHS 160. Unlike the flower topology of FIG. 24, however, the topology at FIG. 30 may handle in addition to the BHS 160 failure a simultaneous AP station 140 failure. When an AP station 140 fails, the AP rectangular grid mesh will accommodate AP 140 hopping. While AP 140 hopping is not desirable as it causes some MSDU traffic congestion in the network, It would be needed only in catastrophic situations in which multiple network nodes fail. The network variant of FIG. 30 is therefore more robust to nodal failure than the less elaborate flower topology of FIG. 24. The variant of FIG. 30 also whimsically resembles a flower, not unlike that of FIG. 24, but with more petal-like graphics representing multiple AP stations 140.

The Motorola CANOPY® design is an application of mobile radio network design (cellular telephony) applied to wireless networking. While mobile radio networks are wireless to some extent, they are frequently wireless only in terms of having mobile stations and not in terms of having stations at higher levels in the mobile radio network, such as base stations or the PSTN. Base stations and PSTNs are typically hardwired into the telephone networks. An important design criterion for typical mobile radio network design is that a single mobile station should not lose wireless service provided by a base station. But the underlying hexagonal star for AP 140 to BHS 160 connections makes the entire CANOPY® network vulnerable to the failure of a BHS 160 station, as reflected in increased MSDU traffic congestion caused by AP 140 hopping. The effects are exacerbated by adjacent BHS 160 failures or the failure of a BHS on the periphery of the hexagonal CANOPY® mesh and by instances in which a satellite AP 140 in a star affected by BHS 160 failure, has to roam and seek another AP station 140 through which to relay its MSDUs to an operational BHS 160.

Yet in a wireless network, eventual temporary failure of a BHS 160 is inevitable. In a fully wireless data communication network, the most important design criterion is that the AP station 140 not lose interconnectivity with the internet gateway co-located with each BHS 160. If a connection is lost through the failure of a BHS 160, the AP station 140 must be able with a minimum of delay to re-route MSDUs to another operational BHS 160.

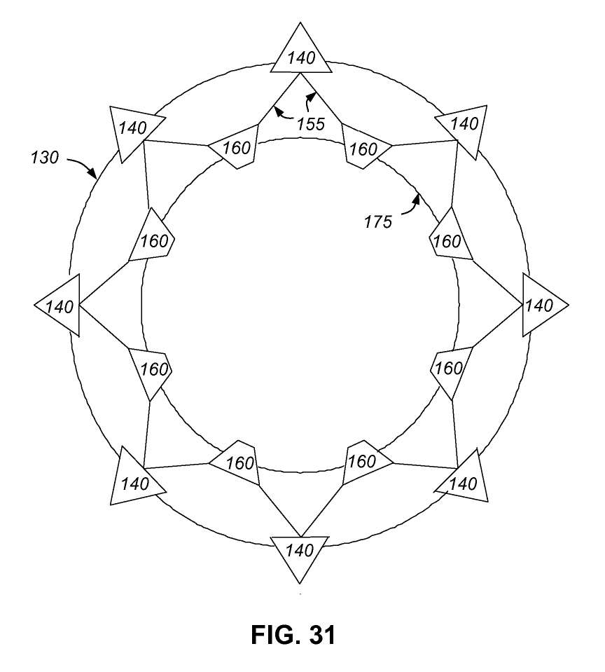

FIG. 31 illustrates a variant of the inventive technology. It is a modification of FIG. 24; in FIG. 31, central control station 190 and links 185 have been omitted. The resulting network retains the triangular ring mesh interlinking AP stations 140 and BHSs 160 that are illustrated in FIGS. 23 and 24, and to that extent embodies the present invention. In FIG. 31, the functions that in the FIG. 24 network would be performed by the central control station 190 are instead performed by all, or a selected one or ones, of the BHSs 160. This alternative functionality can be accomplished by providing suitable routing (using suitable routing hardware and routing software) and control functions, which latter may also include load balance, and bandwidth and traffic management. The details of such routing and control functions are not per se part of the present invention; rather, the present invention relates to network topology and infrastructure that can serve as a suitable foundation for implementation of effective signal communication and routing within a wireless network. Note that the topology of FIG. 31 could be modified, if desired, by providing additional backbone links 175 from one or more BHSs 160 to other BHSs 160, in order to facilitate the effective implementation of control and routing functions. Otherwise routing of control data packets through a series of BHSs 160 may be required before a given control command is implemented by a selected BHS 160.

The inventive flower network described herein has redundancy of AP 140 links sufficient to eliminate or reduce the need for AP 140 hopping, with the objective that each AP station 140 should, if possible, not lose interconnectivity with a nearby BHS 160, or if direct interconnectivity is lost, should be able to establish remote connectivity via a neighboring AP station 140, with a minimum of hopping. This redundancy in most cases of node failure preserves linkage sufficient for access of each AP station 140 to an internet gateway at all times.

The inventive flower topology described herein need not necessarily comply with IEEE 802.11 standards for wireless networks. It may be applied to other networks defined by the IEEE 802 family of standards or by other standards such as those being advanced by the Internet Engineering Task Force (IETF), the International Standards Organization (ISO), the International Electrotechnical Commission (IEC) or others. IEEE 802.16 (Broadband Wireless Access (BWA) Working Group), a standard family still in development, would include the use of frequencies from 2 to 11 Ghz for local and metropolitan area networks. IEEE 802.20 (Mobile Broadband Wireless Access (MBWA) Working Group), a standard family still in its infancy, would use frequencies from 10 to 66 GHz, primarily for mobile network interconnectivity. IEEE 802.22 (Standard for Wireless Regional Area Networks (WRAN)—Specific requirements—Part 22: Cognitive Wireless RAN Medium Access Control (MAC) and Physical Layer (PHY) Specifications: Policies and procedures for Operation in the TV Bands), also in its infancy, would incorporate on an AP station 140 a GPS so that the AP station 140 could control delivery of services to its associated ESS 150 stations, including television and radio operating at VHF and UHF frequencies (54 MHz to 862 MHz). The inventive flower topology can be used with any of these standards, as it is standards-independent.

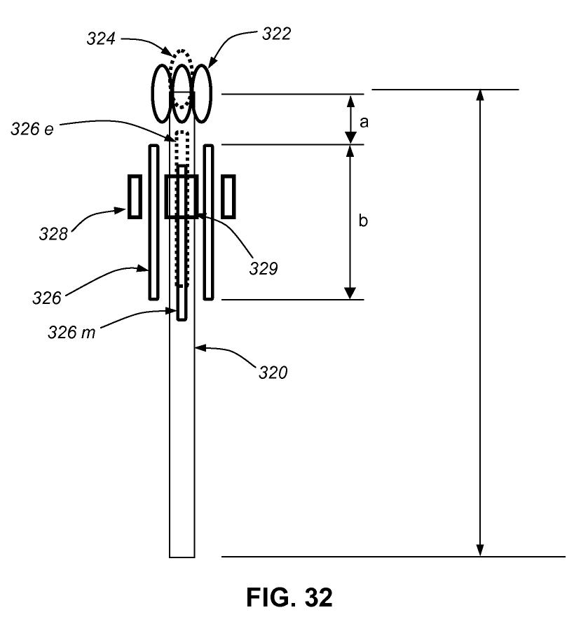

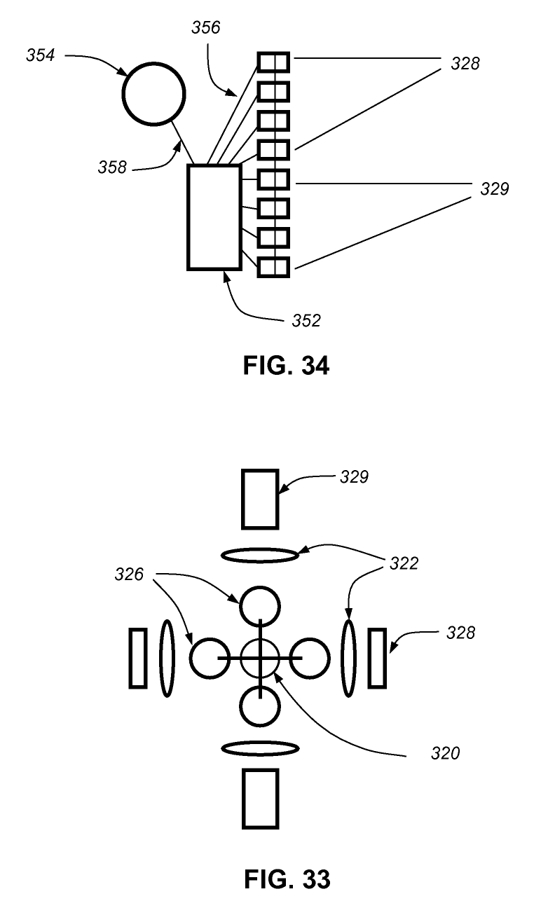

FIGS. 32 and 33 are schematic illustrations of an antenna mast and associated radios suitable for use with a station in a multipath network in accordance with various aspects of the invention. Fixed to a mast (anchorpole) 320 is a configuration 322 of top-mounted sector antennae symmetrically positioned about the mast 320; the central one of these, shown as antenna 324, is shown in broken lines as being vertically adjustable; all four antennae in the cluster 322 are preferably individually capable of both vertical adjustment and angular adjustment relative to the horizontal. Additionally or alternatively, the mast 320 may be provided with a vertically adjustable extension on which the antennae 324 are mounted. Although four antennae are illustrated as being in the cluster 322, fewer than four or more than four could be selected, and the angle of the effective transmission/reception cone for each antenna selected accordingly. While 3600 coverage (in the horizontal sense) is provided by the cluster 322 illustrated, the angle of coverage may be designed to be less than 3600 for some stations, as may be suitable.

Also shown in the illustrations are four symmetrically mounted radio mounting posts 326 radially offset from the mast 320; as mounted on the mast 320, these are individually vertically adjustable, as represented in broken and solid lines by mounting post position limits 326e and 326m. Mounted on each post 326 are radios 328, 329; the radios schematically illustrated are of two different types angularly spaced alternately about the mast 320. Radios 328 are presumed to be higher-frequency radios and radios 329 are presumed to be lower-frequency radios.

The mounting posts 326 should be spaced from the antennae 322 by a distance “a” selected to provide adequate protection against interference while keeping dimensions short in the interest of structural stability and cost of manufacture. The mounting posts 326 are shown as having a length “b” selected to permit adequate adjustability of the posts 326 on the mast 320 and adequate adjustability of radios 328, 329 on the posts 326. Sufficient adjustability should be designed so as to enable antenna polarization to be provided. Dimension “c”, representing the height of the antenna cluster 322 above the surface above which the mast 320 extends, should be chosen for effective transmission and reception of signals by the individual antennae 322 and effective structural clearance of obstacles, etc. Preferably the entire structure should be sufficiently tall that vandalism is discouraged and the risk of chance encounters with moving objects is minimized.

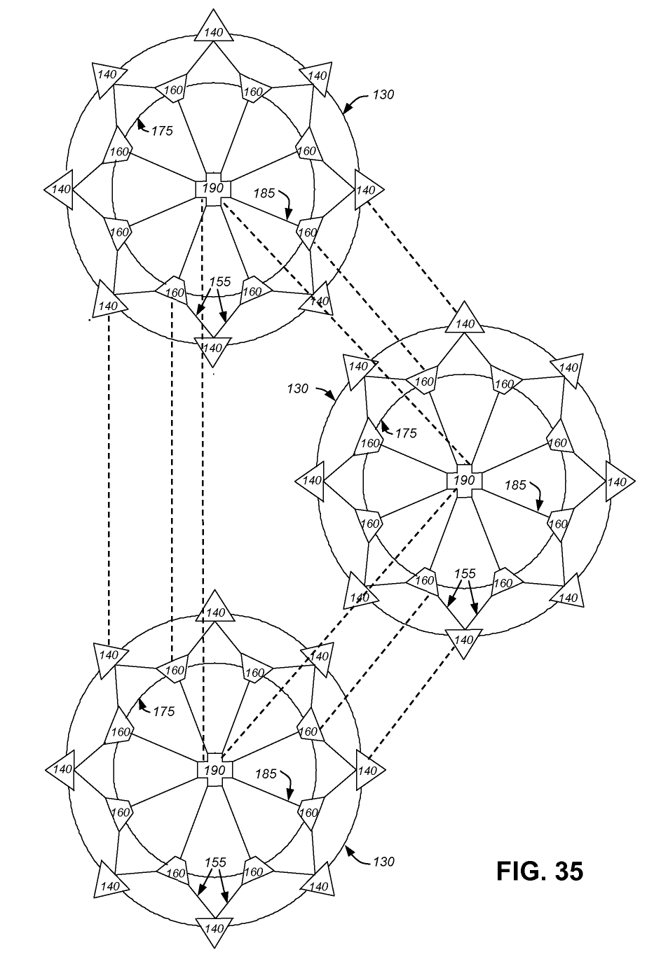

In FIG. 34, a router 352 is provided with an exemplary eight Ethernet ports 356 for individual coupling to radios 328 and 329. (Note that although only four radios are illustrated in FIGS. 32, 33, eight are shown by way of illustration in FIG. 34. Of course, it is expected that the numbers will match, or that some Ethernet ports for router 352 will be left unconnected.) The Ethernet ports 356 could be stacked in conformity with layering of networks or subnetworks served by the ports, and of course more or fewer ports may be made available as required by the system. The circle 354 schematically represents a gateway, node or other connectivity point linked to another level in the network hierarchy; for example, an internet or intranet connection. The link 358 between the connectivity point 354 and the router 352 may be wireless or wired; equally the router connections 356 between the router ports and the radios 328 and 329 may be wireless or wired; the routers preferably function as “plug and play” devices. If the connectivity point 354 is an internet gateway, then the arrangement of FIG. 34 is suitable for use as part of a caching gateway, and could function as part of a central control station or might simply serve as a relay station, and may include “smart switch” functioning in accordance with suitable known control technology. For example, router control may be in accord with previously known techniques such as the RFC techniques to which reference was made earlier in this specification. The lower-frequency radios 329, each operating in a different channel within a selected lower-frequency spectrum and with channel spacing selected to minimize interference, will normally provide downlinks from the station to lower-level stations in the hierarchy, for example from a BHS 160 to an AP 140. The higher-frequency radios 328, each operating in a different channel within a selected higher frequency spectrum and with channel spacing selected to minimize interference, will normally provide uplinks from the station to higher-level stations in the hierarchy, for example from a BHS 160 to a central control station 190.

The preferred operation of the router and related elements of FIG. 34 is within the discretion of the designer. At any given location, the local systems engineer may wish to modify the design to meet local conditions. Routing and controlling software and programs are not per se part of the present invention. While most complex networks have idiosyncrasies not shared by other networks, and therefore very few universal solutions to complex network problems will be available to the designer or to network maintenance personnel, some problems are sufficiently analogous in character that some guidelines may assist the designer to devise a suitable solution for a given individual network. The following observations may be helpful.

One of the guidelines that underlies solutions to node or link failure of the sort discussed above is to provide in each data-packet header sufficient data that each data packet may be (i) passed along an efficient route and (ii) directed ultimately to its intended destination. These objectives are, of course, achieved in part under the control of software specific to the particular network under consideration, making use of suitable routing and control apparatus. As there is no generalized implementation of these objectives, since equipment choices and software generation will be made to suit individual circumstances, an empirical approach that takes into account useful design/operational guidelines is preferred.

In a multipath context, it is useful to distinguish between steady-state operation and a breakdown situation. In steady-state operation, the controller and router (or controllers and routers) may be expected to perform the following operations, or some suitable equivalent thereof:
1. Establish in the data-packet header of each data packet addresses for node origin and final destination node (the latter presumably being the ultimate customer destination for a message in many cases; it will also be useful to include data identifying the customer's service provider, either within the data packet itself or by way of applying a given rule at an intermediate node).
2. Establish a preferred signal routing path for all data packets originating at a given node and intended for a given destination node or for an ultimate destination.
3. At each node through which a data packet passes, direct and route the data packet to follow an efficient route that will, in the absence of breakdown, lead to the ultimate destination.
4. Deliver the packet to its intended recipient at the ultimate destination, again by a suitable combination of process control and routing.

In the event of link breakdown (including situations that are not true failures but may be reflective of transient conditions such as very high traffic over a given link), the system will attempt to implement steps 1 to 4 above but will fail to do so. In that event, the system will function substantially as follows:
1. The controller at a selected node will respond to the breakdown. This response may be triggered by a variety of possible causes, including traffic congestion over a given link, or by a link failure.
2. The controller may be programmed to attempt, at least in some circumstances, a RETRY of the routing that had initially been selected for the data packet.
3. After any RETRY or similar steps have been taken unsatisfactorily, the controller may be programmed to test signal availability over one or more alternative paths that would enable data packets intended for delivery to the same interim node or the same ultimate destination (or family of related ultimate destinations) to reach such destination.
4. If data are available as to signal strength and traffic conditions over alternative signal paths found to be available, the controller will select that path that appears to be optimal. The controller will then provide routing instructions to routers affected so that the alternative path selected is operatively implemented for data packets affected.
5. Optionally, the controller may periodically retry the originally preferred signal path to determine whether it has become re-established, and if so, may direct the routers to revert to their original path selections.

Note that the success of the foregoing breakdown remedy depends upon the availability of one or more alternative signal paths for a given data packet to reach a given destination. Further, the efficiency of the alternative signal path will be dependent upon the number of hops that may be required from node to node in order to enable the data packet to reach its target destination. This implies that the foregoing methodology can be optimized if a flower-type (triangular-mesh type) redundancy of signal paths is available between any two nodes in the network that are intended to be directly linked.

Note also that the methodology above, with suitable modifications, can be applied to connection of the network to alternative service providers, e.g. internet service providers. If the internet service normally made available by one service provider fails, the foregoing methodology may be applied to generate quickly and automatically an alternative path selection to an alternative service provider.

Note further that in a wireless network context, the foregoing methodology makes possible roaming and handoff operations that do not require that a directly affected node conduct such operations. Rather, because the system can be entirely digital and entirely wireless, and the data packets themselves contain all of the necessary origin and destination information required to perform roaming and handoff successfully, the network designer may elect to have such operations performed at any specified one (or more than one, or alternative ones) of the network nodes. The other nodes may in such case function essentially as repeater or relay nodes.

FIG. 35 illustrates schematically three interconnected networks or subnetworks, each conforming to the topology of FIG. 24. Whether the three are considered to be three networks or three subnetworks of a more comprehensive network is largely a semantic consideration. For the purposes of the present discussion, the three are treated as subnetworks of a larger network embracing the subnets.

The following connections illustrated in FIG. 35 are in addition to the links illustrated in FIG. 24: The three central controlling stations 190 are connected to one another by backbone links. At a lower level in the hierarchy, backhaul stations (BHSs) 160 are each connected to two sister BHSs 160, one in each of the other two . At the lowest hierarchical level illustrated, AP stations 140 are each connected to two sister AP stations 140, one in each of the other two layers. This arrangement facilitates multipath deployment, improving robustness and facilitating load balance in response to traffic demands, in that more handover options are available because of the greater number of links accessible to a given station. For simplicity, only one set of sister interconnections of BHSs 160 and one set of sister interconnections of AP stations 140 are illustrated in FIG. 35, but it is preferable that each BHS 160 be linked to two sister BHSs 160, one in each adjacent subnet, and similarly that each AP station 140 be linked to two sister AP stations 140, one in each adjacent subnet. Routers serving layered network arrangements such as that of FIG. 35 may be stacked to accord with the subnet arrangement. Various “smart switches” or other control devices useful for implementing handover techniques may be included at strategic nodes in the network as deemed useful. Suitable such routers, control devices and associated control software are known per se and are not as such part of the present invention.

Variants of what has been described herein will occur to those skilled in network technology. The invention is not limited by the examples described and illustrated, but extends to variants within the scope of the appended claims.

What is claimed is:

1. A predominantly wireless communications network of linked stations in a hierarchy of at least two layers of stations comprising higher-level stations and lower-level stations, characterized by a topology for the two layers in which higher-level stations are each redundantly linked to at least two lower-level stations in a ring network, and lower-level stations are each redundantly linked to at least two higher-level stations in a ring network, each of the ring networks being unique.

2. A communications network as defined in claim 1, wherein the higher-level stations are each redundantly linked to at least two lower-level stations in a triangular ring network (triangular mesh).

3. A communications network as defined in claim 2, wherein the selected lower-level stations are each redundantly linked to at least two higher-level stations in a triangular ring network (triangular mesh).

4. A communications network as defined in claim 2, wherein neigbouring higher-level stations are connected in a series of ring networks to neighbouring ones of a family of lower-level stations.

5. A communications network as defined in claim 4, wherein neigbouring ones of families of lower-level stations are connected in a series of ring networks to a neigbouring pair of higher-level stations.

6. A communications network as defined in claim 5, wherein the lower-level stations in selected families are interconnected by a backbone link, thereby forming rectangular meshes.

7. A communications network as defined in claim 6, wherein all the families of lower-level stations are selected.

8. A communications network as defined in claim 3, additionally including means for effecting automatic handover to an alternate link of a failed or unavailable link.

9. A wireless communications network of linked stations in a hierarchy of at least two sequential levels of stations comprising higher-level stations and lower-level stations, characterized by a topology for the two selected sequential levels in which there is a redundancy of communications links between the lower-level stations and the higher-level stations, so that a failure in any said link is inherently remedied by use of an alternate said link to maintain direct connectivity of the lower-level stations to selected ones of said higher-level stations.

10. A communications network as defined in claim 9, additionally including means for effecting automatic handover to an alternate said link of a failed or unavailable said link.

11. A wireless communications network of linked stations in a hierarchy of at least two sequential layers of stations comprising higher-level stations and lower-level stations, characterized by a selected suitable flower topology for the stations and their links.
